(19) United States
(12) Patent Application Publication
(10) Pub. No.: US 2018/0017657 A1
(43) Pub. Date: Jan. 18, 2018

(54) WIRELESS COMMUNICATION APPARATUS, WIRELESS COMMUNICATION SYSTEM, AND ESTIMATION METHOD

(71) Applicant: FUJITSU LIMITED, Kawasaki-shi (JP)

(72) Inventor: Chikara KOJIMA, Yokohama (JP)

(73) Assignee: FUJITSU LIMITED, Kawasaki-shi (JP)

(21) Appl. No.: 15/624,353

(22) Filed: Jun. 15, 2017

(30) Foreign Application Priority Data
Jul. 12, 2016 (JP) 2016-137660

(51) Int. Cl. G01S 3/28; H04W 88/02

(52) U.S. Cl. CPC G01S 3/28; H04W 88/02

(57) ABSTRACT

A wireless communication apparatus includes a receiver configured to receive a plurality of beams output from external devices, the beams having directions different from each other, respectively, a memory, a processor coupled to the memory and configured to decide ranking of receiving powers of beams based on the receiving powers received by the receiver, calculate an estimated direction of the beam corresponding to the highest receiving power based on comparison of a receiving power whose ranking decided by the ranking is a predetermined ranking or lower with a receiving power whose ranking is higher than the predetermined ranking, and output a signal indicating the calculated estimated direction.

### CROSS-REFERENCE TO RELATED APPLICATION(S)

This application is based upon and claims the benefit of priority of the prior Japanese Patent Application No. 2016-137660, filed on Jul. 12, 2016, the entire contents of which are incorporated herein by reference.

### FIELD

The embodiments discussed herein are related to a wireless communication apparatus, a wireless communication system, and an estimation method.

### BACKGROUND

Conventionally, there is known a wireless communication technique of estimating a direction of a user on a receiving side (wireless communication apparatus) through beam searching, and performing beamforming on a transmitting side based on the estimated direction. For example, there is known a technique of transmitting a beam for searching while changing a beam azimuth in sequence, and estimating as a user azimuth a beam azimuth at which the receiving power at a user becomes largest (see B. Yin, et. al, “High-Throughput Beamforming Receiver for Millimeter Wave Mobile Communication”, GLOBECOM, December 2013, pp. 3802 to 3807, for example).

There is also known a technique of calculating an angle of arrival of radio wave by defining a degree of imbalance from measured values of differences of the reception level of a beam corresponding to the highest reception level of radio wave and from the reception levels of two beams adjacent to that beam (see Japanese Laid-open Patent Publication No. 02-206776, for example). Moreover, there is known a technique of combining received signals at each of two sets of antennas, and estimating a direction of arrival of radio wave from the magnitude of the difference between the combined signals (see Japanese Laid-open Patent Publication No. 10-070502, for example).

### SUMMARY

According to an aspect of the invention, a wireless communication apparatus includes a receiver configured to receive a plurality of beams output from external devices, the beams having directions different from each other, respectively, a memory, a processor coupled to the memory and configured to decide ranking of receiving powers of beams based on the receiving powers received by the receiver, calculate an estimated direction of the beam corresponding to the highest receiving power based on comparison of a receiving power whose ranking decided by the ranking is a predetermined ranking or lower with a receiving power whose ranking is higher than the predetermined ranking, and output a signal indicating the calculated estimated direction.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a communication system according to Embodiment 1;

FIG. 2 is a (first) diagram illustrating an example of timing of down beamforming in the communication system according to Embodiment 1;

FIG. 3 is a (second) diagram illustrating an example of timing of down beamforming in the communication system according to Embodiment 1;

FIG. 4 is a diagram illustrating an example of a base station and a terminal according to Embodiment 1;

FIG. 5 is a diagram illustrating an example of a beam azimuth estimation unit of the terminal according to Embodiment 1;

FIG. 6 is a diagram illustrating an example of a searching beam pattern in the communication system according to Embodiment 1;

FIG. 7 is a diagram illustrating an example of a ranking error rate to an azimuth in the communication system according to Embodiment 1;

FIG. 8 is a diagram illustrating an example of rankings of receiving powers of searching beams corresponding to a position of the terminal according to Embodiment 1;

FIG. 9 is a diagram illustrating an example of each beam ID ranking in accordance with the receiving power by the terminal according to Embodiment 1;

FIG. 10 is a flow chart illustrating an example of azimuth estimation processing by the terminal according to Embodiment 1;

FIG. 11 is a sequence diagram illustrating an example of processing between the base station and the terminal according to Embodiment 1;

FIG. 12 is a (first) diagram illustrating an example of derivation of an estimation beam ID by the terminal according to Embodiment 1;

FIG. 13 is a (second) diagram illustrating an example of derivation of an estimation beam ID by the terminal according to Embodiment 1;

FIG. 14 is a (third) diagram illustrating an example of derivation of an estimation beam ID by the terminal according to Embodiment 1;

FIG. 15 is a (fourth) diagram illustrating an example of derivation of an estimation beam ID by the terminal according to Embodiment 1;

FIG. 16 is a diagram illustrating other example of the base station and the terminal according to Embodiment 1;

FIG. 17 is a sequence diagram illustrating other example of processing between the base station and the terminal according to Embodiment 1;

FIG. 18 is a diagram illustrating an example of improvement in estimation throughput according to Embodiment 1;

FIG. 19 is a diagram illustrating other example of the improvement in the estimation throughput according to Embodiment 1;

FIG. 20 is a diagram illustrating an example of a degree of dispersion of an estimation error in receiving power to SNR in Embodiment 1;

FIG. 21 is an example illustrating an example of improvement in SINR characteristics according Embodiment 1;

FIG. 22 is a diagram illustrating other example of the improvement in the SINR characteristics according to Embodiment 1;

FIG. 23 is a diagram illustrating an example of a countermeasure for an exception by an estimation method according to Embodiment 1;

FIG. 24 is a flow chart illustrating an example of azimuth estimation processing including exception processing by the terminal according to Embodiment 1;

FIG. 25 is a diagram illustrating an example of beam searching according to an Embodiment 2;

FIG. 26 is a flow chart illustrating an example of transmission processing of a searching beam from a base station according to Embodiment 2;

FIG. 27 is a flow chart illustrating an example of azimuth estimation processing by a terminal according to Embodiment 2;

FIG. 28 is a diagram illustrating an example of a beam azimuth estimation unit of a terminal according to an Embodiment 3;

FIG. 29 is a diagram illustrating an example of an azimuth to be judged in estimation azimuth correction by the terminal according to Embodiment 3;

FIG. 30 is a diagram illustrating an example of an electric power difference between continuous rankings to an azimuth in a communication system according to Embodiment 3;

FIG. 31 is a diagram illustrating an example of the estimation azimuth correction by the terminal according to Embodiment 3;

FIG. 32 is a flow chart illustrating an example of azimuth estimation processing by the terminal according to Embodiment 3;

FIG. 33 is a flow chart illustrating an example of estimation azimuth correction processing by the terminal according to Embodiment 3;

FIG. 34 is a diagram illustrating other example of the estimation azimuth correction by the terminal according to Embodiment 3;

FIG. 35 is a flowchart illustrating other example of the estimation azimuth correction processing by the terminal according to Embodiment 3;

FIG. 36 is a (first) diagram illustrating an example of derivation of an estimation beam ID by the terminal according to Embodiment 3;

FIG. 37 is a (second) diagram illustrating an example of the derivation of the estimation beam ID by the terminal according to Embodiment 3;

FIG. 38 is a (third) diagram illustrating an example of the derivation of the estimation beam ID by the terminal according to Embodiment 3;

FIG. 39 is a (fourth) diagram illustrating an example of the derivation of the estimation beam ID by the terminal according to Embodiment 3;

FIG. 40 is a (fifth) diagram illustrating an example of the derivation of the estimation beam ID by the terminal according to Embodiment 3;

FIG. 41 is a diagram illustrating an example of improvement in throughput according to Embodiment 3;

FIG. 42 is a diagram illustrating other example of the improvement in the throughput according to Embodiment 3;

FIG. 43 is a diagram illustrating an example of improvement in the throughput in consideration of an overhead amount according to Embodiment 3; and

FIG. 44 is a diagram illustrating other example of the improvement in the throughput in consideration of the overhead amount according to Embodiment 3.

### DESCRIPTION OF EMBODIMENTS

In the aforementioned conventional technologies, there is a problem that when an estimation error in receiving powers on the receiving side is large, a user direction may not be estimated with precision, for example.

In one aspect, the embodiments aim to provide a wireless communication apparatus, a wireless communication system, and an estimation method that may improve estimation precision of a user direction.

In the following, with reference to the drawings, embodiments of the wireless communication apparatus, the wireless communication system, and the estimation method according to the disclosure are described in detail.

### Embodiment 1

(Communication System According to Embodiment 1)

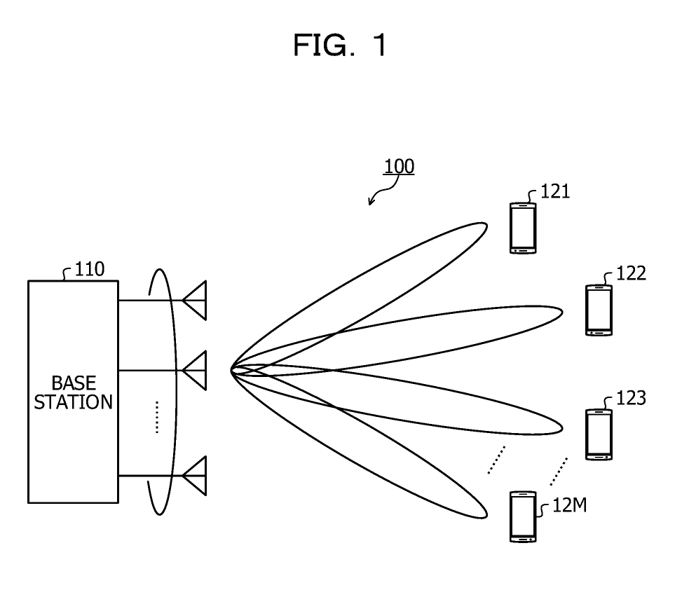

FIG. 1 is a diagram illustrating an example of a communication system according to Embodiment 1. As illustrated in FIG. 1, a communication system 100 according to Embodiment 1 includes a base station 110 and terminals 121 to 12M. As illustrated in FIG. 1, for example, the base station 110 performs multiuser multiplexing beamforming that wirelessly transmits a down data signal to the terminals 121 to 12M simultaneously, through beamforming using a plurality of antennae.

(Timing of Down Beamforming in the Communication System According to Embodiment 1)

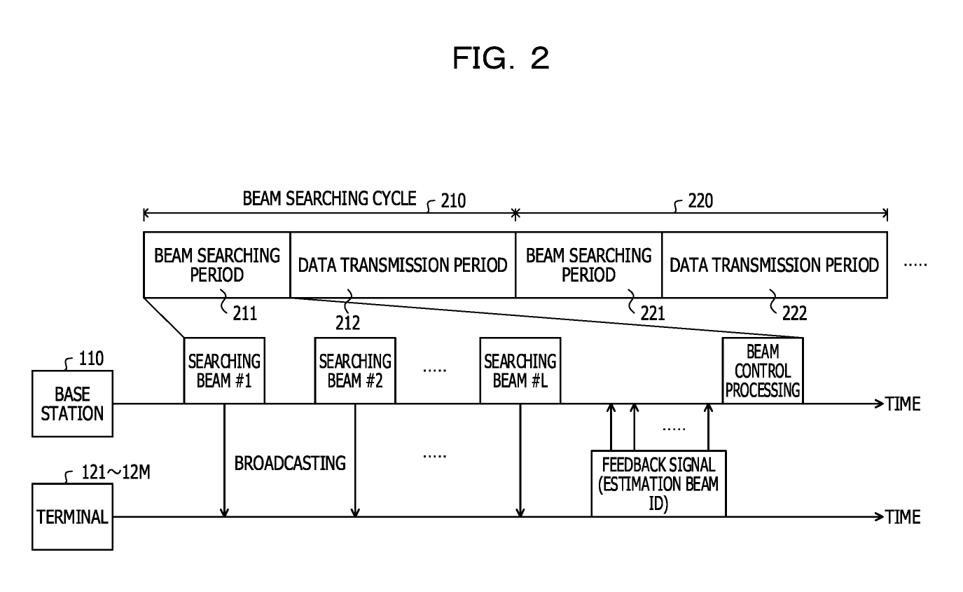

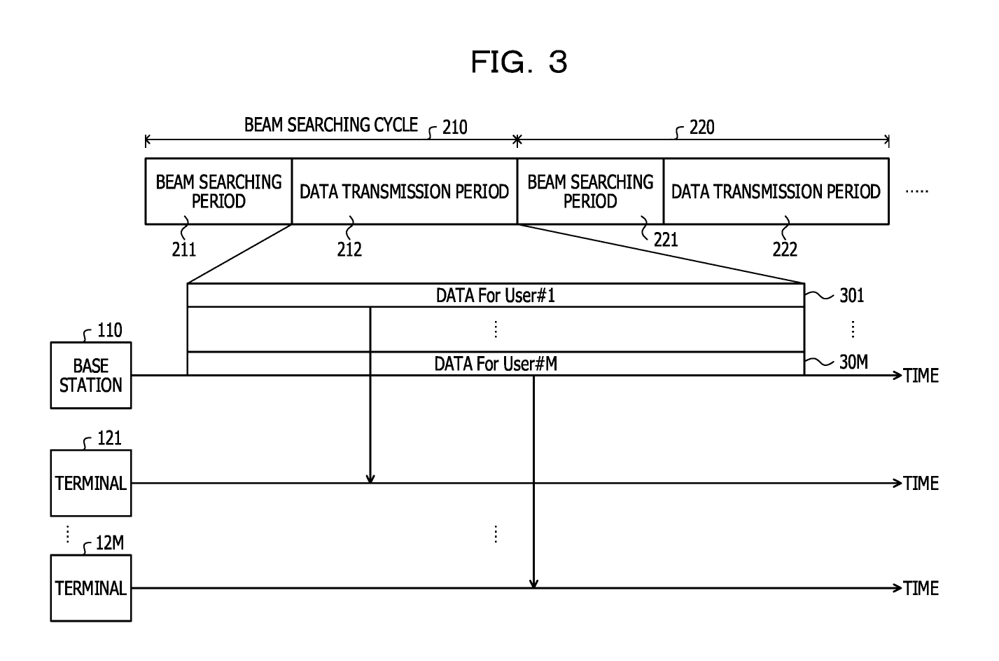

FIGS. 2 and 3 are diagrams illustrating an example of timing of down beamforming in the communication system according to Embodiment 1. In FIGS. 2 and 3, the horizontal axis represents time. Beam searching cycles 210, 220 are beam searching and data transmission cycles. For example, the beam searching cycle 210 includes a beam searching period 211 and a data transmission period 212. In addition, the beam searching cycle 220 includes a beam searching period 221 and a data transmission period 222. In addition, a predetermined guard time may be provided between the beam searching period 211 and the data transmission period 212 or between the beam searching period 221 and the data transmission period 222.

As illustrated in FIG. 2, in the beam searching period 211, for example, the base station 110 sequentially transmits searching beams #1, #2, . . . , #L each having a different azimuth (beam azimuth) through broadcasting. Each of the searching beams #1, #2, . . . , #L is a wireless beam to which a beam ID=1, 2, . . . , L is assigned, for example. In addition, each of the searching beams #1, #2, . . . , #L may store information that indicates its own beam ID.

Next, each of the terminals 121 to 121M estimates a beam ID of a searching beam with the largest receiving power, of the searching beams #1, #2, . . . , #L received from the base station 110. Then, each of the terminals 121 to 121M transmits a feedback signal indicating the estimated beam ID (estimation beam ID) to the base station 110.

Next, based on each feedback signal received from the terminals 121 to 121M, the base station 110 performs beam control processing that controls beam azimuth to transmit in multiuser multiplexing beamforming. This ends the beam searching period 211. During the beam searching period 211, data transmission from the base station 110 does not take place so that no interference between the searching beams #1, #2, . . . , #L and data occurs.

The searching beams #1, #2, . . . , #L may be transmitted at the lowest rate that may be set, for example. This may improve reception precision of the searching beams #1, #2, . . . , #L in the terminals 121 to 121M.

As illustrated in FIG. 3, in the data transmission period 212, for example, the base station 110 simultaneously transmits data 301 to 30M (data For User#1 to #M) to the terminals 121 to 12M at the beam azimuth set in the beam searching period 211. In such data transmission with multiuser multiplexing, interference occurs among the users. In contrast to this, the base station 110 performs the beam control processing described above so that such interference among users becomes small.

(Base Station and Terminal According to Embodiment 1)

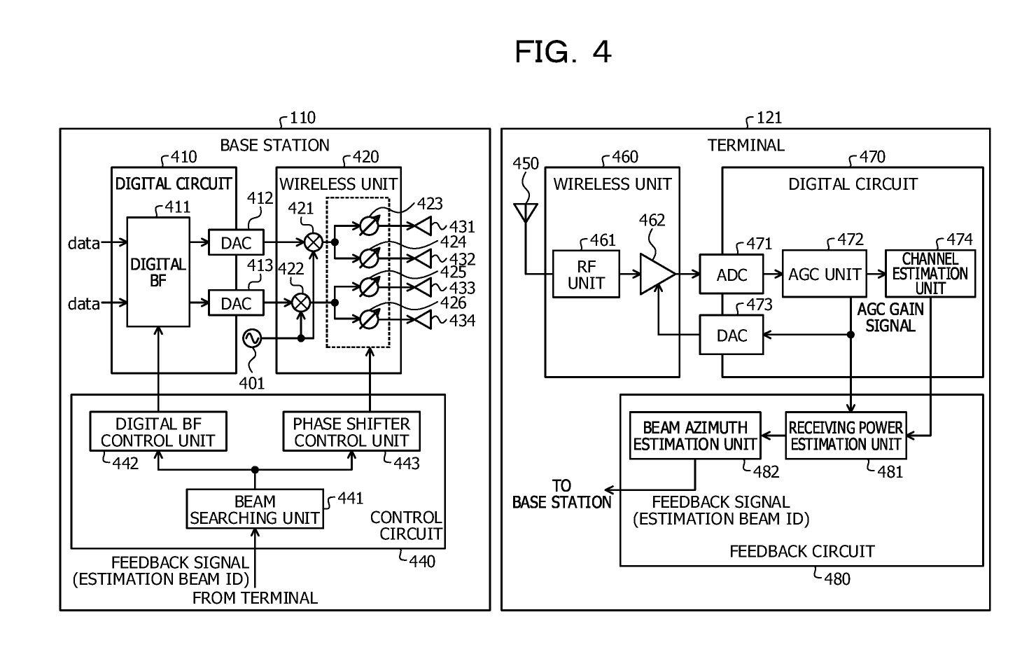

FIG. 4 is a diagram illustrating an example of the base station and the terminal according to Embodiment 1. As illustrated in FIG. 4, the base station 110 includes an LO 401, a digital circuit 410, a wireless unit 420, antennae 431 to 434, and a control circuit 440, for example. LO stands for Local Oscillator. LO 401 oscillates a clock signal of a predetermined frequency and outputs the oscillated clock signal to the wireless unit 420.

The digital circuit 410 includes a digital beamforming unit 411 (digital BF) and DACs 412, 413. DAC stands for Digital/Analog Converter. The digital circuit 410 may be implemented by such a digital circuit as a field programmable gate array (FPGA) or a digital signal processor (DSP).

Data (data) for each terminal on a transmission destination is input into the digital beamforming unit 411. The digital beamforming unit 411 uses a beam weight (weighting factor) of beamforming set by the control circuit 440 to perform weighting to each entered data. Then, the digital beamforming unit 411 outputs each signal obtained through weighting to the DACs 412, 413.

Each of the DACs 412, 413 converts the signal output from the digital beamforming unit 411 from a digital signal to analog signal, and outputs to the wireless unit 420 the signal which is converted to the analog signal.

The wireless unit 420 includes mixers 421, 422 and phase shifters 423 to 426. The mixer 421 multiples a signal output from the DAC 412 by a clock signal output from the LO 401, thereby frequency converting the signal output from the DAC 412 into a radio frequency (RF: high frequency) band. Then, the mixer 421 outputs the frequency converted signal to the phase shifters 423, 424.

The mixer 422 multiplies a signal output from the DAC 413 by the clock signal output from the LO 401, thereby frequency converting the signal output from the DAC 413 to an RF band and outputting the frequency converted signal to the phase shifters 425, 426.

Each of the phase shifters 423, 424 phase shifts the signal output from the mixer 421 with beam weight set by the control circuit 440, thereby weighting the signal output from the mixer 421. Then, the phase shifters 423, 424 output the weighted signal to each of the antennae 431, 432. One sub-array is implemented by the phase shifters 423, 424.

Each of the phase shifters 425, 426 phase shifts the signal output from the mixer 422 with the beam weight set by the control circuit 440, thereby weighting the signal output from the mixer 422. Then, the phase shifters 425, 426 outputs the weighted signal to each of the antennae 433, 434. One sub-array is implemented by the phase shifters 425, 426.

Each of the antennae 431 to 434 wirelessly transmits a signal output from the wireless unit 420. With this, each signal weighted by the digital circuit 410 and the wireless unit 420 is wirelessly transmitted from the antennae 431 to 434.

The control circuit 440 includes a beam searching unit 441, a digital beamforming control unit 442 (digital BF control unit), and a phase shifter control unit 443. The control circuit 440 may be implemented by such a digital circuit as an FPGA, a DSP, a central processing unit (CPU), or the like.

A feedback signal that the base station 110 wirelessly receives from the terminals 121 to 121M is input to the beam searching unit 441. The beam searching unit 441 outputs to the digital beamforming control unit 442 and the phase shifter control unit 443 an estimation beam ID of each terminal that is indicated by the input feedback signal.

The digital beamforming control unit 442 generates each beam weight in the digital beamforming unit 411 based on the estimation beam ID of each terminal output from the beam searching unit 441. Then, the digital beamforming control unit 442 controls beamforming in the digital circuit 410 by setting the generated beam weight in the digital beam forming unit 411.

The phase shifter control unit 443 generates each beam weight in the phase shifters 423 to 426 based on the estimation beam ID of each terminal output from the beam searching unit 441. Then, the phase shifter control unit 443 controls beamforming in the phase shifters 423 to 426 by setting the generated beam weight in each of the phase shifters 423 to 426.

Note that the number of antennae, sub-arrays, phase shifters, mixers, DAC, or the like in the base station 110, for example, may be changed, irrespective of the configuration illustrated in FIG. 4.

A configuration of the terminal 121 is described hereinafter. While the configuration of the terminal 121 is described, configurations of the terminals 122 to 12M are also similar to the configuration of the terminal 121. The terminal 121 includes an antenna 450, a wireless unit 460, a digital circuit 470, and a feedback circuit 460, for example. The antenna 450 receives a signal wirelessly transmitted from the base station 110 and outputs the received signal to the wireless unit 460.

The wireless unit 460 includes an RF unit 461 and an amplifier 462. The RF unit 461 frequency converts a signal output from the antenna 450 from an RF band to a baseband band, and outputs the frequency converted signal to the amplifier 462. The amplifier 462 amplifies the signal output from the RF unit 461 with a gain indicated by an AGC gain signal output from the digital circuit 470 and outputs the amplified signal to the digital circuit 470. AGC stands for Automatic Gain Control.

The digital circuit 470 includes an ADC 471, an AGC unit 472, a DAC 473, and a channel estimation unit 474. ADC stands for Analog/Digital Converter. The digital circuit 470 may be implemented by a digital circuit such as an FPGA or a DSP, or the like. The ADC 471 converts a signal output from the wireless unit 460 from an analog signal to a digital signal and outputs the signal, which is converted to the digital signal, to the AGC unit 472.

The AGC unit 472 performs AGC processing that controls a gain of amplification in the amplifier 462 by outputting to the DAC 473 an AGC gain signal to the amplifier 462. The AGC unit 472 also adjusts a gain indicated by an AGC gain signal output to the DAC 473 so that strength of the signal output from the ADC 471 is fixed, for example.

For example, when strength of the signal output from the ADC 471 is lower than a predetermined target value, the AGC unit 472 increases the gain indicated by the AGC gain signal. In addition, when the strength of the signal output from the ADC 471 is larger than the predetermined target value, the AGC unit 472 decreases the gain indicated by the AGC gain signal.

A signal output from the AGC unit 472 to the DAC 47 is also output to the feedback circuit 480. The DAC 473 converts the AGC gain signal output from the AGC unit 472 from a digital signal to an analog signal and outputs the AGC gain signal, which is converted to the analog signal, to the amplifier 462. The AGC unit 472 also outputs the signal output from the ADC 471 to the channel estimation unit 474.

The channel estimation unit 474 performs channel estimation (estimation of an impulse response of a propagation path, for example) between the base station 110 and the terminal including the channel estimation unit 474, based on the signal output from the AGC unit 472. Then, the channel estimation unit 474 outputs to the feedback circuit 480 a channel estimation value obtained through the channel estimation.

When a signal transmitted by the base station 110 is an OFDM signal, for example, the channel estimation unit 474 performs channel estimation for each subcarrier of the OFDM signal and outputs to the feedback circuit 480 a channel estimation value for each subcarrier. OFDM stands for Orthogonal Frequency Division Multiplexing.

The feedback circuit 480 includes a receiving power estimation unit 481 and a beam azimuth estimation unit 482. The feedback circuit 480 may be implemented by such a digital circuit as an FPGA, a DSP, a CPU or the like.

The receiving power estimation unit 481 measures receiving power at the terminal of a signal wirelessly transmitted from the base station 110, based on an AGC gain signal output from the digital circuit 470 and a channel estimation value. In addition, measurement of receiving power is performed by the receiving power estimation unit 481 for each beam azimuth (beam ID) of a searching beam transmitted from the base station 110, for example. The receiving power at the terminal of the signal wirelessly transmitted from the base station 110 may be represented by the following expression (1):

$$P = \frac{1}{{G}_{AGC} + {e}_{q \_ agc} + n} {\sum }_{K = 0}^{K - 1} {\vert {h}_{k} + {e}_{q \_ hest} + n \vert}^{2} \qquad ( 1 )$$

In the expression (1) above, G_{AGC} is a true value of a gain in AGC when a packet is received. hₖ is a channel estimation value of a subcarrier k in a case in which a signal transmitted by the base station 110 is an OFDM signal. K is the number of all subcarriers for which a channel estimation value is present. e_{q}_{_}_{agc} is a quantization error in AGC by the AGC unit 472. e_{q}_{_}ₕₑₛₜ is a quantization error in channel estimation by the channel estimation unit 474. n is a noise error.

Therefore, the receiving power estimation unit 481 divides a total value of channel estimation values (hₖ) of each subcarrier that are output from the channel estimation unit 474 by gain (G_{AGC}) indicated by the AGC gain signal output from the AGC unit 472. With this, a receiving power at the terminal of a signal wirelessly transmitted from the base station 110 may be estimated. However, an estimation result of this receiving power includes an error due to e_{q}_{_}_{agc}, e_{q}_{_}ₕₑₛₜ, and n or the like. The receiving power estimation unit 481 notifies the beam azimuth estimation unit 482 of receiving power of each estimated beam ID.

Based on the receiving power notified by the receiving power estimation unit 481, the beam azimuth estimation unit 482 estimates a beam ID (estimation beam ID) indicating a beam azimuth with the largest receiving power (reception quality) at the terminal, of beam azimuths at which the base station 110 wirelessly transmits a signal. Then, the beam azimuth estimation unit 482 performs estimation according to ranking of receiving powers to be described below. Then, the beam azimuth estimation unit 482 outputs a feedback signal indicating the estimated estimation beam ID. The feedback signal output from the beam azimuth estimation unit 482 is wirelessly transmitted to the base station 110 by the wireless transmitter the terminal 121 includes.

In the terminal 121, a receiver configured to receive a plurality of searching beams transmitted from the base station 110 and having different directions may be implemented by the antenna 450, the wireless unit 460, and the digital circuit 470, for example. In addition, a calculation unit configured to calculate an estimated direction of a beam from the base station 110 and having the largest receiving power at the terminal may be implemented by the feedback circuit 480, for example. In addition, the transmitter configured to transmit to other wireless communication apparatus a signal indicating the estimated direction calculated by the calculation unit may be implemented by the wireless transmitter the terminal 121, for example, includes.

(Beam Azimuth Estimation Unit of the Terminal According to Embodiment 1)

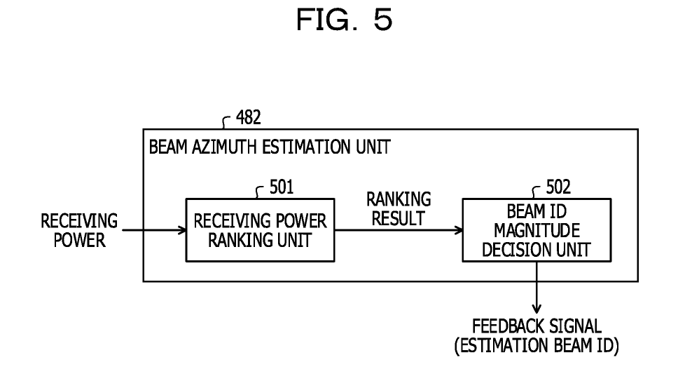

FIG. 5 is a diagram illustrating an example of a beam azimuth estimation unit of the terminal according to Embodiment 1. As illustrated in FIG. 5, the beam azimuth estimation unit 482 includes a receiving power ranking unit 501 and a beam ID magnitude decision unit 502, for example.

The receiving power ranking unit 501 rankings beam IDs according to receiving power of each beam ID notified from the receiving power estimation unit 481 (see FIG. 4), so that receiving powers are ranked in descending order. For example, among the beam IDs, a beam ID with the highest estimated receiving power is the first-ranking beam ID. The receiving power ranking unit 501 notifies the beam ID magnitude decision unit 502 of a result of the ranking of the beam IDs according to the receiving powers.

The beam ID magnitude decision unit 502 makes beam ID size judgment, to be described below, based on the ranking result of the beam IDs according to the receiving powers notified by the receiving power ranking unit 501. Then, the beam ID magnitude decision unit 502 determines an estimation beam ID indicating a beam azimuth with the largest receiving power at the terminal, of beam azimuths at which the base station 110 wirelessly transmits a signal, and outputs a feedback signal indicating the determined estimation beam ID.

(Pattern of a Searching Beam in the Communication System According to Embodiment 1)

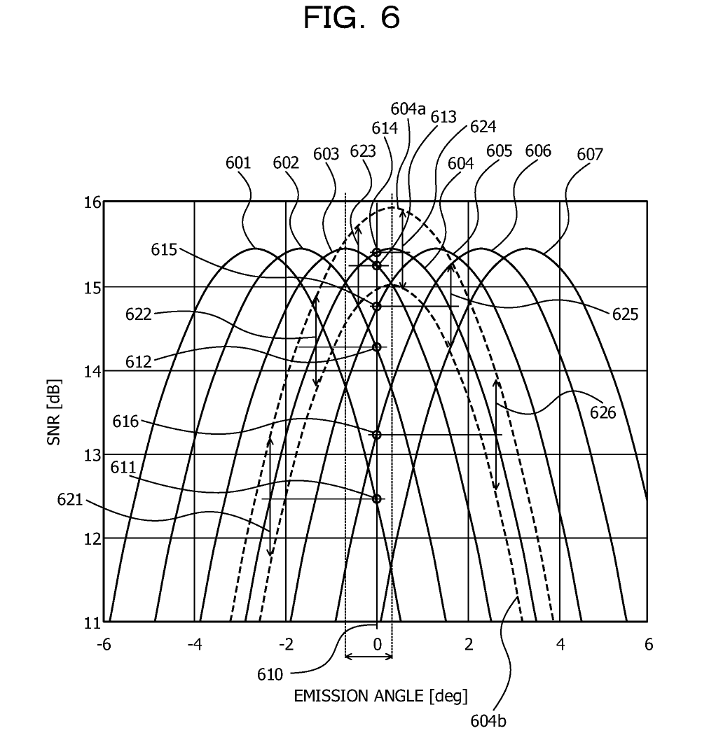

FIG. 6 is a diagram illustrating an example of a searching beam pattern in the communication system according to Embodiment 1. In FIG. 6, the horizontal axis represents an emission angle [deg] of a searching beam transmitted by the base station 110, and the vertical axis represents SNR [dB]. SNR stands for Signal to Noise Ratio.

Beam patterns 601 to 607 are beam patterns that are transmitted from the base station 110 and do not include an error of searching beams, each having a different emission angle (beam ID). A beam pattern 604a is a beam pattern with SNR of the beam pattern 604 being highest due to an error. A beam pattern 604b is a beam pattern with the SNR of the beam pattern 604 being lowest due to the error.

For example, suppose that emission angle 610 (0 [deg]) is an azimuth at which the terminal 121 is located, more specifically, an emission angle of a beam that is optimal to the terminal 121. The SNR 611 to 616 each represents SNR of when the terminal 121 receives beams of the beam patterns 601 to 606 from the base station 110. In the example illustrated in FIG. 6, the SNR 614 is highest, the SNRs 613, 615, 612, 616, and 611 becoming lower in this order.

Dispersive width 621 to 626 each represents dispersive width of the SNRs 611 to 616. For example, the dispersive width 624, 623 of the SNRs 614, 613 for which SNRs are ranked first and second almost overlap. In contrast to this, the dispersive width 626, 621 of the SNRs 616, 611 for which SNRs are ranked fifth and sixth have a few overlapping parts. More specifically, the lower the ranking of receiving power is, the lower SNR is and the wider dispersive width of an error is. Since a difference in the receiving power between rankings becomes larger, however, there is robustness to variations.

(Ranking Error Rate to an Azimuth in the Communication System According to Embodiment 1)

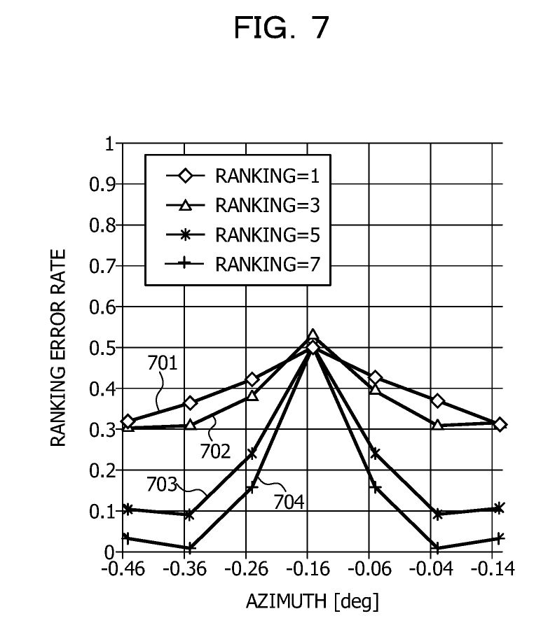

FIG. 7 is a diagram illustrating an example of ranking error rate to an azimuth in the communication system according to Embodiment 1. In FIG. 7, the horizontal axis represents the azimuth [deg] and the vertical axis represents the ranking error rate. The ranking error rate is a percentage that ranking of receiving power at a terminal is misjudged due to an estimation error of the receiving power. Ranking error rate characteristics 701 to 704 indicate characteristics of an error rate of ranking of receiving powers in searching beams of azimuths each having first-ranking to fourth-ranking receiving power. As illustrated in the ranking error rate characteristics 701 to 704, an area having lower ranking of receiving power (receiving power being smaller) has a lower error rate of ranking of receiving powers.

Using this, the beam ID magnitude decision unit 502 refers to beam IDs having a lower ranking of receiving power to determine an estimation beam ID. This makes it possible to determine with precision an estimation beam azimuth at which receiving power in the terminal is largest, of azimuths of beams wirelessly transmitted by the base station 110, even if there is an estimation error in receiving powers.

(Ranking of Receiving Power of a Searching Beam Corresponding to a Position of the Terminal According to Embodiment 1)

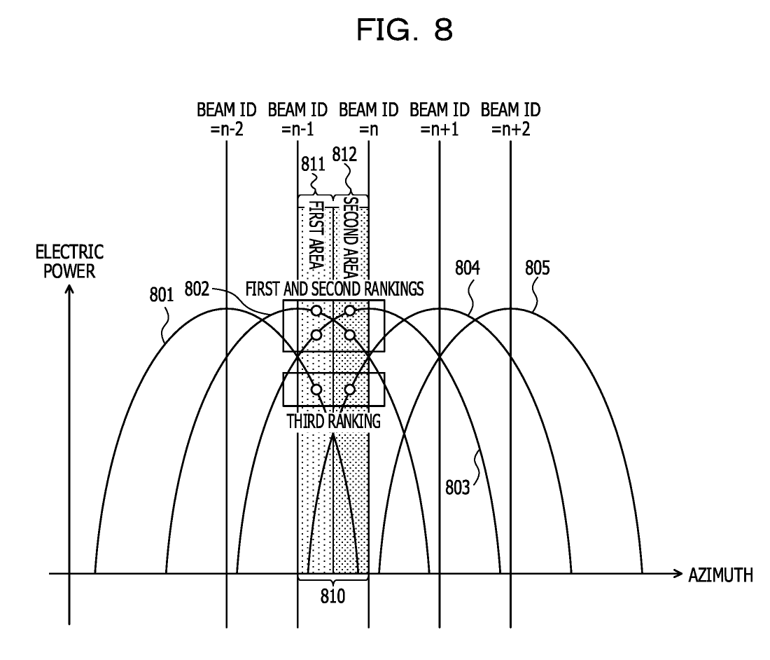

FIG. 8 is a diagram illustrating an example of rankings of receiving powers of searching beams corresponding to a position of the terminal according to Embodiment 1. In FIG. 8, the horizontal axis represents an azimuth and the vertical axis represents electric power. Beam patterns 801 to 805 each indicate a beam pattern of a searching beam a beam ID of which is n−2, n−1, n, n+1, and n+2. In addition, in the example illustrated in FIG. 8 is described a case in which an estimation beam ID is determined using a beam ID whose receiving power at the terminal 121 is ranked third. Also suppose that the larger a beam ID is, the larger an azimuth [deg] is.

For example, suppose that the terminal 121 is located in an azimuth area 810. The area 810 is an area between a center azimuth of the beam pattern 802 and a center azimuth of the beam pattern 803. In this case, rankings of respective beam IDs according to receiving powers in the terminal 121 vary depending on whether the terminal 121 is located in a first area 811 or a second area 812 of the area 810. Of the area 810, the first area 811 is an area closer to the center azimuth of the beam pattern 802 than to a center azimuth of the beam pattern 803. Of the area 810, the second area 812 is an area closer to the center azimuth of the beam pattern 803 than to the center azimuth of the beam pattern 802.

For example, when the terminal 121 is located in the first area 811, receiving power of the beam pattern 802 is ranked first, receiving power of the beam pattern 803 is ranked second, and receiving power of the beam pattern 801 is ranked third. Then, the beam ID=n−2 of the third-ranking beam pattern 801 is smaller at all times than the beam IDs=n−1 and n of the first-ranking and the second-ranking beam patterns 802 and 803, which are ranked higher than the beam pattern 801.

Therefore, when the beam ID with the third-ranking receiving power is smaller than each of the beam IDs with the first-ranking and the second-ranking receiving powers, it may be estimated that the terminal 121 is located in the first area 811. Thus, it may be determined that the beam pattern which is closest to the azimuth of the terminal 121 is the beam pattern 802, more specifically, an estimation beam ID of the terminal 121 is n−1.

On the other hand, when the terminal 121 is located in the second area 812, receiving power of the beam pattern 803 is ranked first, receiving power of the beam pattern 802 is ranked second, and receiving power of the beam pattern 804 is ranked third. Then, the beam ID=n+1 of the third-ranking beam pattern 804 is larger at all times than the beam IDs=n−1 and n of the first-ranking and the second-ranking beam patterns 802 and 803.

Therefore, when the beam ID with the third-ranking receiving power is larger than each of the beam IDs with the first-ranking and the second-ranking receiving powers, it may be estimated that the terminal 121 is located in the second area 812. Thus, it may be determined that the beam pattern which is closest to the azimuth of the terminal 121 is the beam pattern 803, more specifically, the estimation beam ID of the terminal 121 is n.

(Each Beam ID Ranking in Accordance with a Receiving Power by the Terminal According to Embodiment 1)

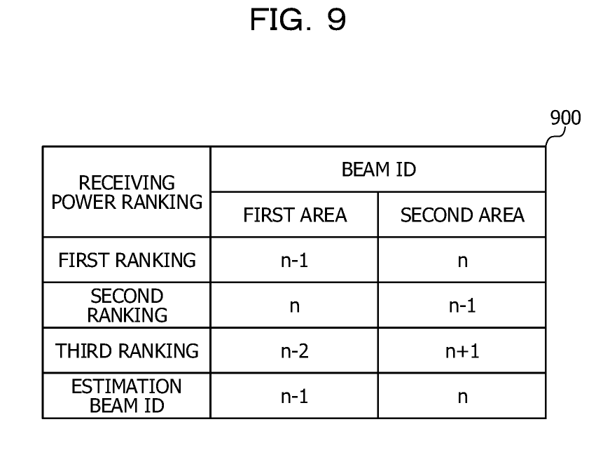

FIG. 9 is a diagram illustrating an example of each beam ID ranking in accordance with the receiving power by the terminal according to Embodiment 1. A table 900 in FIG. 9 indicates rankings of receiving powers in each of cases in which the terminal 121 is located in the first area 811 and in which the terminal 121 is located the second area 812.

For example, when the terminal 121 is located in the first area 811, the first ranking is the beam ID=n−1, the second ranking is the beam ID=n, and the third ranking is the beam ID=n−2. Then, since the third-ranking beam ID=n−2 is smaller than the first-ranking and the second-ranking beam IDs=n−1 and n, it may be determined that the estimation beam ID of the terminal 121 is n−1.

When the terminal 121 is located in the second area 812, the first ranking is the beam ID=n, the second ranking is the beam ID=n−1, and the third ranking is the beam ID=n+1. Then, since the third-ranking beam ID=n+1 is larger than the first-ranking and the second-ranking beam IDs=n and n−1, it may be determined that the estimation beam ID of the terminal 121 is n.

By way of example, suppose that the first ranking is beam ID=ID3, the second ranking is beam ID=ID4, and third ranking is beam ID=ID5 (ID3<ID4<ID5). In this case, since the third-ranking ID is larger than each of the first-ranking and the second-ranking beam IDs, it may be determined that the estimation beam ID of the terminal 121 is ID4.

Additionally, as described above, each beam ID having a higher ranking of receiving power (receiving power being larger) easily changes a ranking of receiving power due to an error. In contrast to this, even if the first ranking and the second ranking are changed in the example illustrated in FIG. 9, for example, the change does not affect an estimation beam ID of the terminal 121 to be determined. With this, even if there is an estimation error in receiving power, a beam ID (beam azimuth) for which receiving power of the terminal 121 increases may be determined with precision.

(Azimuth Estimation Processing by the Terminal According to Embodiment 1)

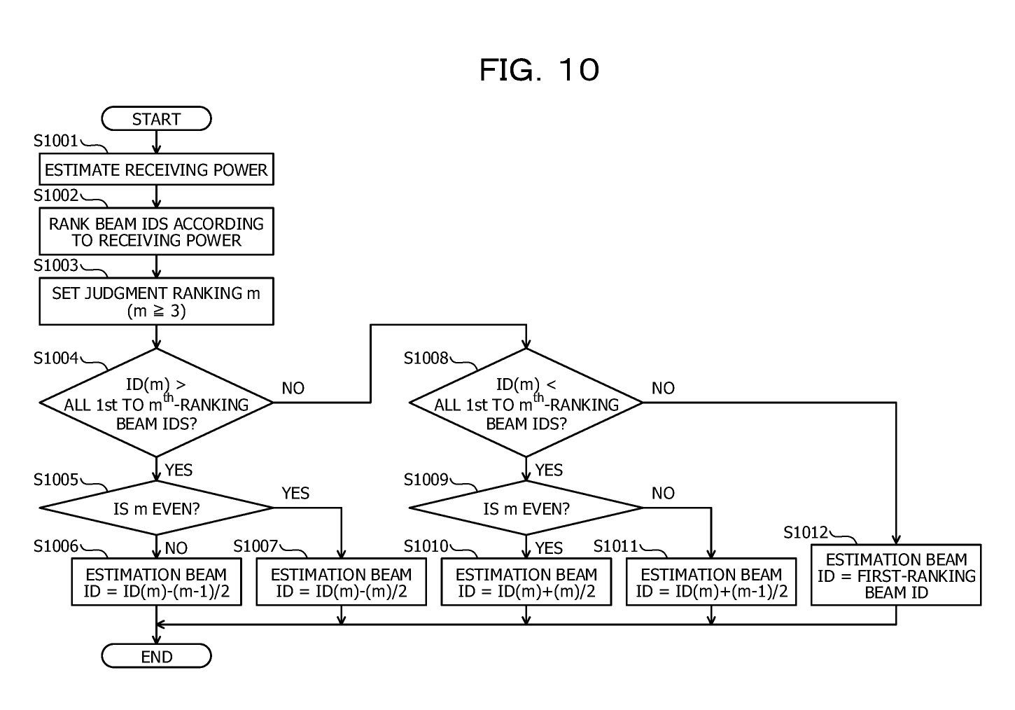

FIG. 10 is a flow chart illustrating an example of azimuth estimation processing by the terminal according to Embodiment 1. While azimuth estimation processing by the terminal 121 is described, azimuth estimation processing by terminals 122 to 12M is also similar. The terminal 121 performs steps illustrated in FIG. 10, for example, as the azimuth estimation processing. Here, suppose that the larger an azimuth of a searching beam is (the right side in FIG. 8, for example), the larger the beam ID is.

First, the terminal 121 first estimates receiving powers of respective searching beams that the base station 110 transmits while changing beam azimuths (beam IDs) (step S1001). Then, the terminal 121 rankings the beam IDs according to the estimated receiving powers in step S1001 (step S1002). For example, the terminal 121 rankings the beam IDs so that receiving powers are in descending order.

Then, the terminal 121 sets a judgment ranking m to compare magnitudes of the beam IDs (step S1003). For example, m may be a value of 3 or larger (more specifically, the judgment ranking m is the third place or lower).

Then, the terminal 121 uses the judgment ranking m set in step S1003 to determine whether or not the beam ID at an m^{th}-ranking in a ranking result in step S1002 is larger than each of the first-ranking to the m−1^{th}-ranking beam IDs (step S1004). Thus, it may be determined whether or not the m^{th}-ranking beam azimuth is the largest among the first-ranking to the m^{th}-ranking beam azimuths (being on the right side in FIG. 8, for example).

In step S1004, when the m^{th}-ranking beam ID is larger than each of the first-ranking to the m−1^{th}-ranking beam IDs (step S1004: Yes), the terminal 121 determines whether or not the judgment ranking m set in step S1003 is an even (step S1005).

In step S1005, when the judgment ranking m is an odd (step S1005: No), it may be determined that the terminal 121 is located in the second area 812. In this case, the terminal 121 calculates an ID(m)−(m−1)/2 as an estimation beam ID (step S1006), and finishes a series of the azimuth estimation processing. ID(x) is a function that returns a beam ID with the x-ranking receiving power.

In step S1005, when the judgment ranking m is an even (step S1005: Yes), it may be determined that the terminal 121 is located in the first area 811. In this case, the terminal 121 calculates ID(m)−(m)/2 as an estimation beam ID (step S1007), and finishes a series of the azimuth estimation processing.

In step S1004, when the m^{th}-ranking beam ID is not larger than at least any of the first-ranking to the m−1^{th}-ranking beam IDs (step S1004: No), the terminal 121 proceeds to step S1008. More specifically, the terminal 121 determines whether or not the result of the ranking in step S1002 is that the m^{th}-ranking beam ID is smaller than each of all the first-ranking to the m−1^{th}-ranking beam IDs (step S1008). Thus, it may be determined whether or not the beam azimuth with the m^{th}-ranking receiving power is the smallest (being the left side in FIG. 8, for example) among the beam azimuths with the first-ranking to the m^{th}-ranking receiving power.

In step S1008, when the m^{th}-ranking beam ID is smaller than each all the first-ranking to the m−1^{th}-ranking beam IDs (step S1008: Yes), the terminal 121 determines whether or not the judgment ranking m set in step S1003 is an even (step S1009).

In step S1009, when the judgment ranking m is an even (step S1009: Yes), it may be determined that the terminal 121 is located in the second area 812. In this case, the terminal 121 calculates ID(m)+(m)/2 as an estimation beam ID (step S1010), and finishes a series of the azimuth estimation processing.

In step S1009, when the judgment ranking m is an odd (step S1009: No), it may be determined that the terminal 121 is located in the area 811. In this case, the terminal 121 calculates ID(m)+(m−1)/2 as the estimation ID (step S1011), and finishes a series of the azimuth estimation processing.

In step S1008, when the m^{th}-ranking beam ID is not smaller than at least any of the first-ranking to the m−1^{th}-ranking beam IDs (step S1008: No), it may be determined that the ranking of the m^{th}-ranking beam ID is changed due to an error in receiving power. By way of example, such a case includes a case in which m=4 and {ID(1)=2, ID(2)=3, ID(3)=6, ID(4)=5}. In such a case, the terminal 121 derives a beam ID with the first-ranking receiving power as an estimation beam ID (step S1012) and finishes a series of the azimuth estimation processing.

The above-mentioned judgment ranking m set in step S1003 may be a preset value, for example. Alternatively, the judgment ranking m may be calculated based on receiving power or the like. For example, based on the receiving power estimation result in step S1001 and the ranking result in step S1002, the terminal 121 calculates, as a judgment ranking m, the lowest ranking with receiving power being more than predetermined electric power. With this, an estimation ID may be determined by excluding a beam ID having a high error rate of searching packets due to small receiving power and being less reliable. Hence, a beam ID (beam azimuth) with increasing receiving power of the terminal 121 may be determined with precision.

Alternatively, using a packet error rate of searching beams corresponding to respective beam IDs and the ranking result in step S1002, the terminal 121 may calculate, as a judgment ranking m, the lowest ranking with the packet error rate being below the predetermined electric power. With this, an estimation beam ID may be determined by excluding a beam ID having a high error rate of searching packets and being less reliable. Hence, a beam ID (beam azimuth) with increasing receiving power of the terminal 121 may be determined with precision. To calculate a packet error rate, error detection such as a cyclic redundancy check (CRC), for example, may be used. In addition, not only the packet error rate but also a bit error rate (BER) or a block error ratio (BLER) may be used.

If an estimation beam ID is determined with the beam ID having the high error rate of searching packets and being less reliable as a reference, the beam ID itself is likely to be a wrong beam ID. Thus, a beam ID with increasing receiving power of the terminal 121 may not be determined with precision. In contrast to this, as described above, making a judgment ranking m a beam ranking having the reception quality, such as a receiving power or an error rate, which is higher than the predetermined quality enables exclusion of a direction having a high beam error rate and being less reliable, and calculation of a beam estimated direction with the largest receiving power. Thus, a user direction may be estimated with precision.

Furthermore, making a judgment ranking m the lowest ranking among the rankings of beams with the reception quality that is higher than the predetermined quality enables calculation of an estimated direction of a beam with the largest receiving power relative to a direction in which changing of rankings of receiving powers due to an estimation error in the receiving powers is most unlikely to occur. Thus, a user direction may be estimated with precision.

In addition, as a result of the ranking in the step S1002, if the first-ranking to the m^{th}-ranking beam IDs have a beam ID of MaxID-m or higher, the terminal 121 is in the neighborhood of an end of a target azimuth of beam searching, and a magnitude relation between the first-ranking to the m^{th}-ranking beam IDs is not as illustrated in FIG. 8. In this case, the terminal 121 does not compare the magnitudes of the respective first-ranking to the m^{th}-ranking beam IDs and derives a beam ID with the first-ranking receiving power, more specifically, ID (1), as an estimation beam ID, for example.

In addition, while the azimuth estimation processing in the case in which a beam ID becomes larger as an azimuth of a searching beam becomes larger (right side in FIG. 8, for example) is described, azimuth estimation processing in a case in which a beam ID becomes smaller as an azimuth of a searching beam becomes larger (right side in FIG. 8, for example) is also similar. In this case, however, the magnitude comparisons in steps S1004 and S1008 are reversed. For example, in step S1004, the terminal 121 determines whether or not the m^{th}-ranking beam ID is smaller than each of all the first-ranking to the m−1^{th}-ranking beam IDs. In step S1008, the terminal 121 also determines whether or not the m^{th}-ranking beam ID is larger than each of all the first-ranking to the m−1^{th}-ranking beam IDs.

(Processing Between the Base Station and the Terminal According to Embodiment 1)

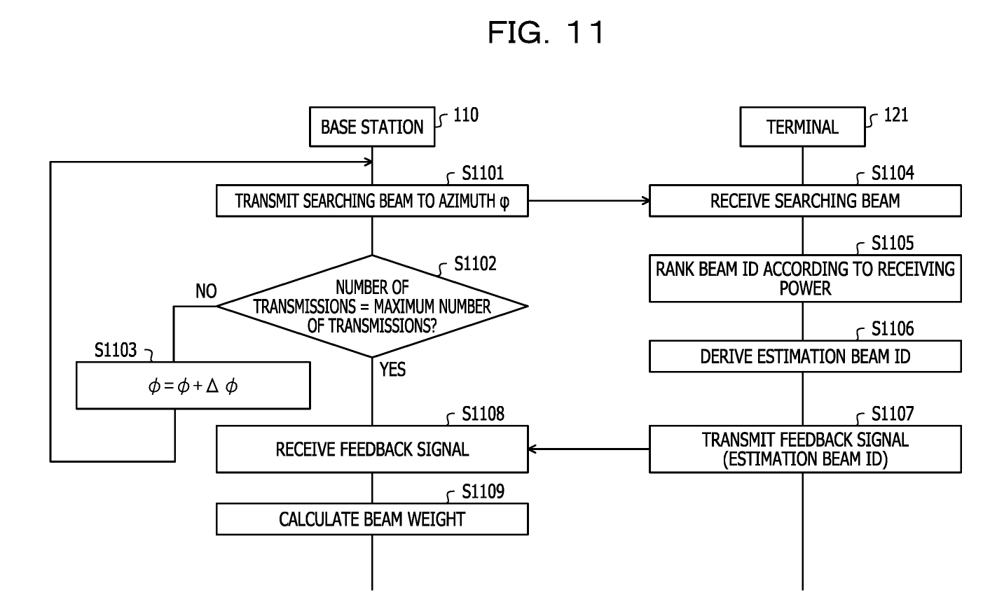

FIG. 11 is a sequence diagram illustrating an example of processing between the base station and the terminal according to Embodiment 1. For example, steps illustrated in FIG. 11 are performed between the base station 110 and the terminal 121 as illustrated in FIG. 4. While the example illustrated in FIG. 11 describes processing between the base station 110 and the terminal 121, processing between the base station 110 and the terminals 122 to 12M is also similar. Suppose that in the base station 110, the smallest azimuth in a searching range of beam searching is set as an initial value of an azimuth φ of a searching beam.

First, the base station 110 transmits a searching beam to the azimuth φ (step S1101). Through the searching beam in step S1101, for example, one searching packet of a predetermined pattern is transmitted. In addition, the searching packet to be transmitted in step S1101 includes a beam ID corresponding to the azimuth φ at that time, for example.

Then, the base station 110 determines whether or not the number of searching beam transmissions in step S1101 reaches the predetermined maximum number of transmissions (step S1102). If the number of transmissions does not reach the maximum number of transmissions (step S1102: No), the base station 110 increases φ only by a predetermined unit amount Δφ (step S1103), and returns to step S1101. If the number of transmissions reaches the maximum number of transmissions (step S1102: Yes), the base station 110 proceeds to step S1108.

On the other hand, the terminal 121 only receives the maximum number of transmissions of the searching beams transmitted by the base station 110 in step S1101 (step S1104). Then, the terminal 121 rankings beam IDs of the searching beams, according to receiving powers of the searching beams received in step S1104 (step S1105).

Then, the terminal 121 derives an estimation beam ID in the terminal 121, based on a result of the ranking in step S1105 (step S1106). Then, the terminal 121 transmits to the base station 110 a feedback signal indicating the estimation beam ID derived in step S1106 (step S1107).

The base station 110 receives the feedback signal transmitted from the terminal 121 in step S1107 (step S1108). Then, the base station 110 calculates beam weights to be used in data transmissions from the base station 110 to the terminals 121 to 12M, based on the estimation beam ID indicated by the feedback signal received from the terminal 121 in step S1108 (step S1109).

In step S1109, the base station 110 calculates the beam weights based on the estimation beam IDs indicated by the feedback signals received from the terminals 121 to 12M, for example, and uses the calculated beam weights to start the data transmissions to the terminals 121 to 12M.

(Derivation of an Estimation Beam ID by the Terminal According to Embodiment 1)

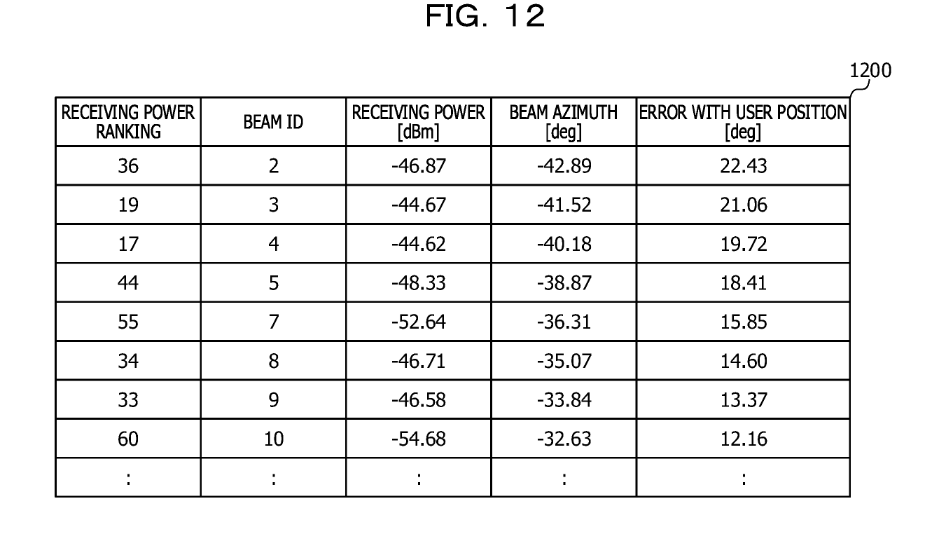

FIGS. 12 to 15 are diagrams illustrating an example of derivation of an estimation beam ID by the terminal according to Embodiment 1. In FIGS. 12 to 15, by way of example, derivation of an estimation beam ID by the terminal 121 is described. A table 1200 in FIG. 12 illustrates a result of reception by the terminal 121 of searching beams from the base station 110.

Beam IDs in the table 1200 are beam IDs of searching beams transmitted by the base station 110. Beam azimuths [degrees] in the table 1200 are azimuths of the searching beams transmitted by the base station 110. In this example, the larger the beam ID is, the larger the beam azimuth is (to the right side of FIG. 8, for example). Errors with a user position [degrees] in the table 1200 are true values of errors between the azimuths of the searching beams transmitted by the base station 110 and azimuths at which the terminal 121 is actually located. More specifically, the beam ID having the smallest error with the user position in the table 1200 is an estimation beam ID with the highest receiving power in the terminal 121.

Receiving powers [dBm] in the table 1200 represent receiving powers in the terminal 121 of the searching beams transmitted by the base station 110. The receiving power rankings in the table 1200 are the rankings (in descending order) of the receiving powers in the table 1200. In the example illustrated in FIGS. 12 to 15, suppose that searching beams of beam IDs=1, 6, for example, are not detected by the terminal 121 because the receiving powers are small.

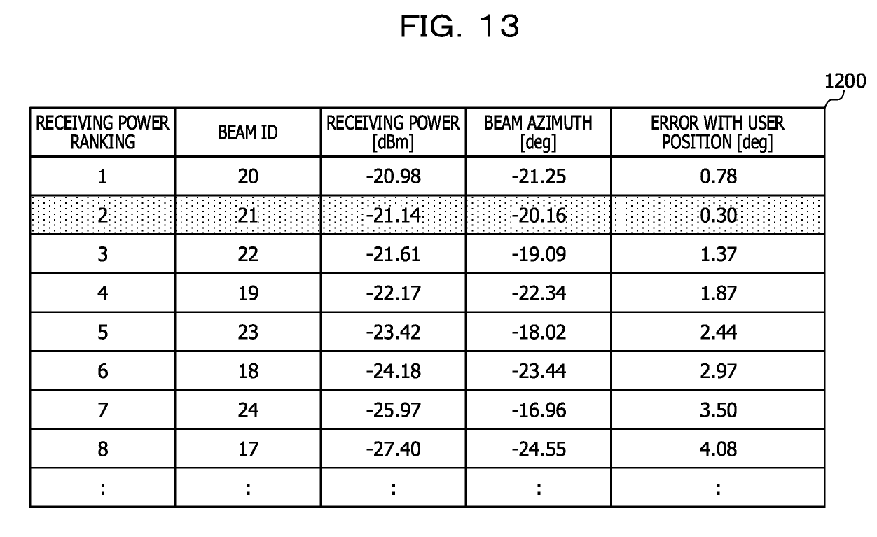

FIG. 13 illustrates the table 1200 illustrated in FIG. 12 in a state sorted according to the receiving power rankings. In the table 1200, while the error with the user position at a beam ID=21 is smallest, the receiving power of the searching beam of the beam ID=21 is lower than the receiving power of the searching beam of a beam ID=20 due to an estimation error in the receiving power. As a result, the receiving power of the searching beam of the beam ID=21 is ranked second.

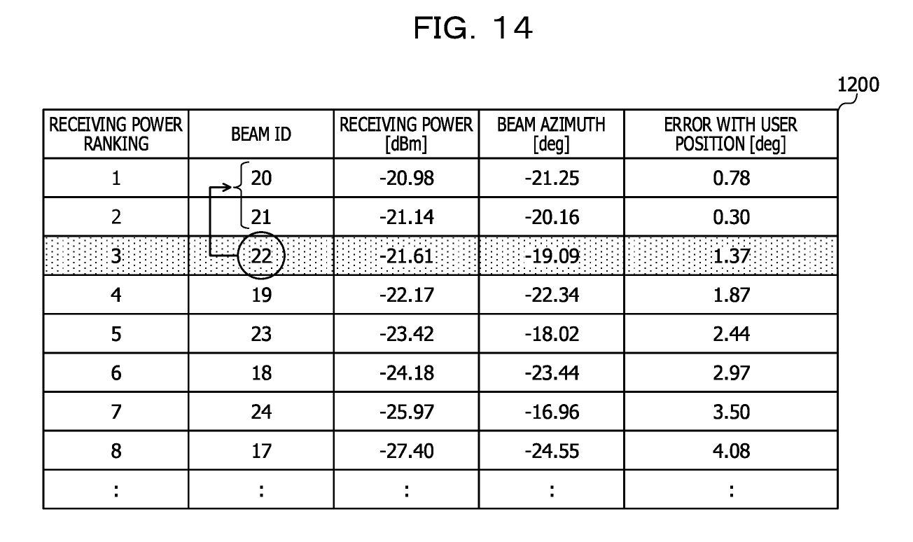

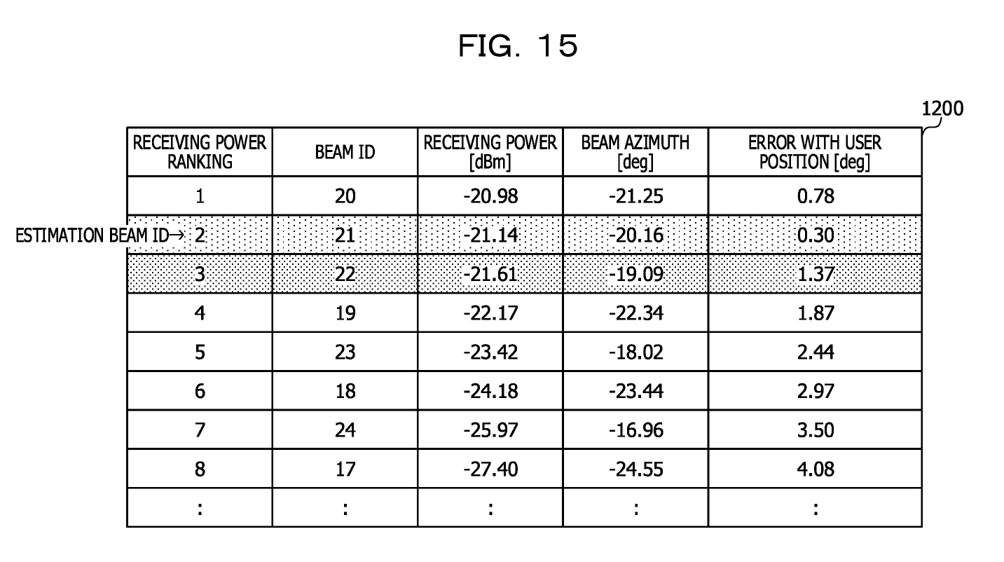

If the judgment ranking m described above is 3, as illustrated in FIG. 14, the terminal 121 compares a beam ID=22 having the third-ranking receiving power with the beam IDs=20, 21 having the first-ranking and the second-ranking receiving powers. Then, since the beam ID=22 is larger than the beam IDs=20, 21 and the judgment ranking m=3 is an odd, the terminal 121 judges an estimation beam ID=21, as illustrated in FIG. 15. With this, the beam ID=21, whose receiving power is ranked second due to the error although offset in the actual azimuth is smallest, may be derived as the estimation beam ID.

(Other Example of the Base Station and the Terminal According to Embodiment 1)

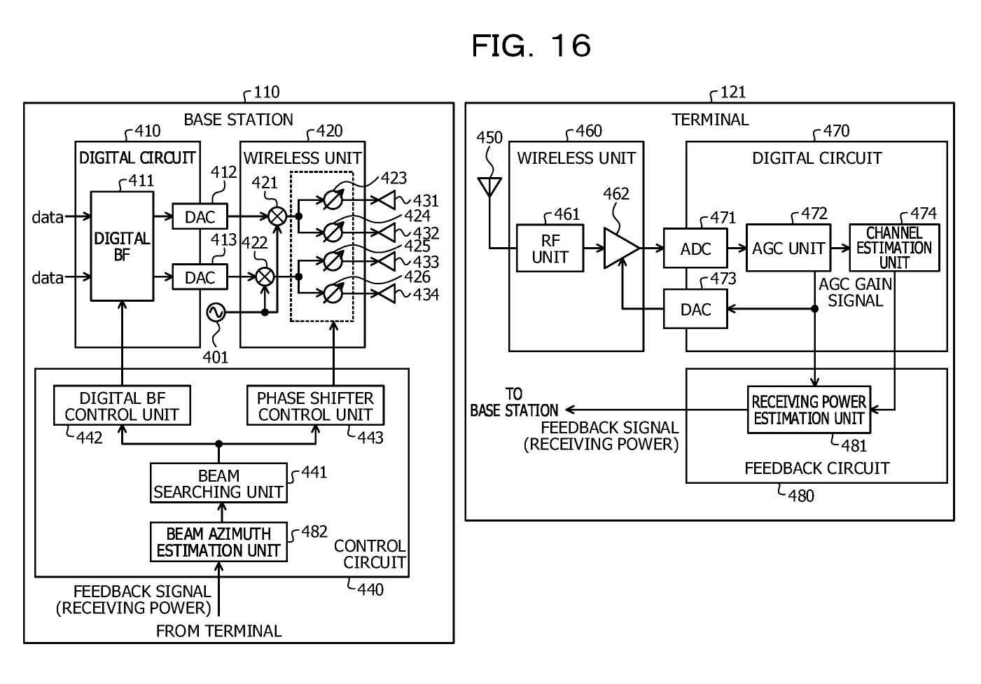

FIG. 16 is a diagram illustrating other example of the base station and the terminal according to Embodiment 1. In FIG. 16, same symbols are assigned to parts similar to the parts illustrated in FIG. 4 and a description is omitted. As illustrated in FIG. 16, the beam azimuth estimation unit 482, which is provided in the terminal 121 in the example illustrated in FIG. 4, may be provided in the control circuit 440 of the base station 110.

In this case, the receiving power estimation unit 481 of the terminal 121 outputs a feedback signal indicating receiving power of each estimated beam ID. The feedback signal output from the receiving power estimation unit 481 is wirelessly transmitted to the base station 110 by a wireless transmitter that the terminal 121 includes.

The beam azimuth estimation unit 482 of the base station 110 estimates a beam ID based on the receiving power of each beam ID indicated by the feedback signal wirelessly transmitted from the terminal 121. Similarly, the beam azimuth estimation unit 482 estimates beam IDs based on receiving powers of beam IDs indicated by feedback signals wirelessly transmitted from the terminals 122 to 12M. Then, the beam azimuth estimation unit 482 notifies the beam searching unit 441 of the estimation beam IDs estimated for each terminal. The beam searching unit 441 outputs to the beamforming control unit 442 and the phase shifter control unit 443 the estimation beam IDs for the terminals which are notified by the beam azimuth estimation unit 482.

As illustrated in FIG. 16, derivation of an estimation beam ID based on receiving power may also be performed in the base station 110, not in the terminals 121 to 12M.

(Other Example of Processing Between the Base Station and the Terminal According to Embodiment 1)

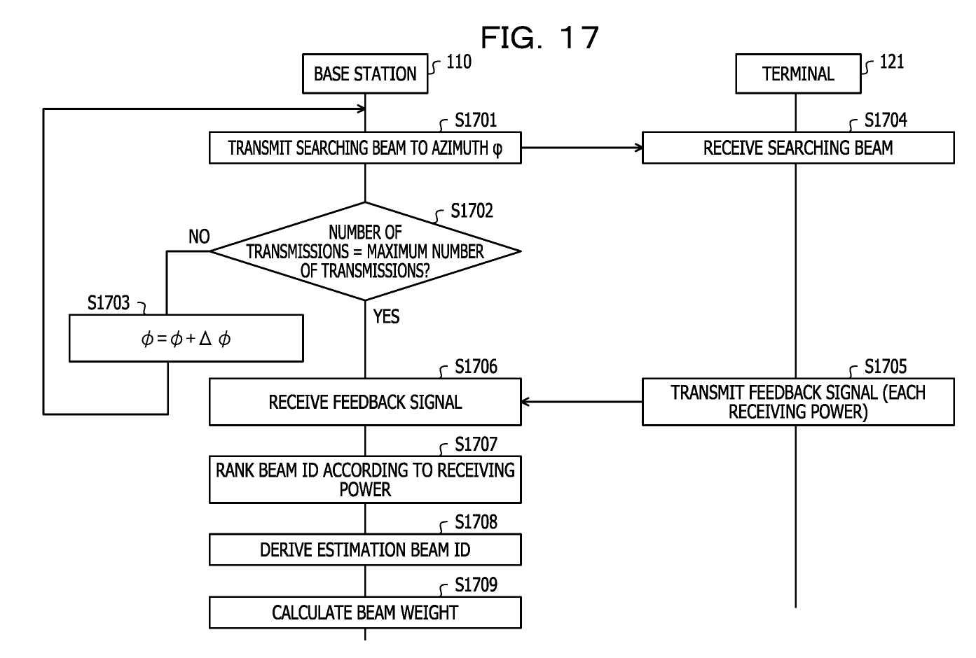

FIG. 17 is a sequence diagram illustrating other example of processing between the base station and the terminal according to Embodiment 1. For example, steps illustrated in FIG. 17 are performed between the base station 110 and the terminal 121 as illustrated in FIG. 16. While the example illustrated in FIG. 17 describes the processing between the base station 110 and the terminal 121, processing between the base station 110 and the terminals 122 to 12M is also similar.

Steps S1701 to S1704 illustrated in FIG. 17 are similar to steps S1101 to S1104 illustrated in FIG. 11. Following step S1704, the terminal 121 transmits to the base station 110 feedback signals indicating receiving powers of the respective searching beams received in step S1704 (step S1705).

The base station 110 receives the feedback signals transmitted from the terminal 121 in step S1705 (step S1706). Then, the base station 110 rankings beam IDs of the searching beams, according to receiving power of the searching beams indicated by the feedback signals received in step S1706 (S1707).

Then, the base station 110 derives an estimation beam ID in the terminal 121, based on the result of the ranking in step S1707 (step S1708). Then, the base station 110 calculates beam weights to be used in data transmissions from the base station 110 to the terminals 121 to 12M, based on the estimation beam ID derived in step S1708 (step S1709).

(Improvement of Estimation Throughput According to Embodiment 1)

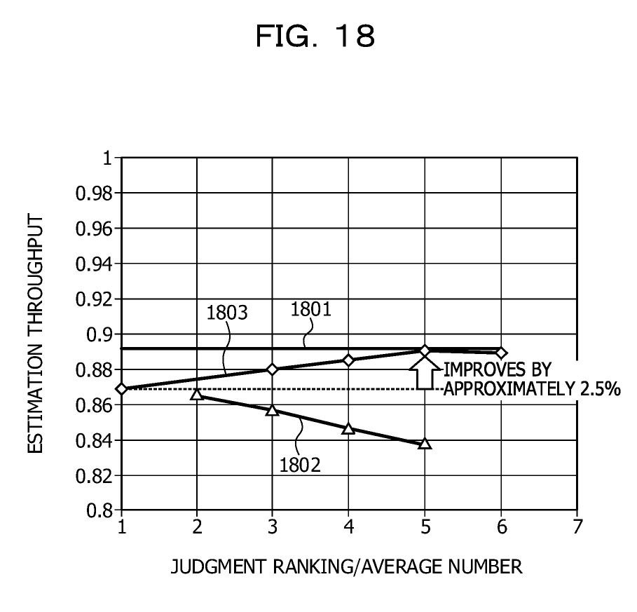

FIG. 18 is a diagram illustrating an example of improvement in estimation throughput according to Embodiment 1. In FIG. 18, the horizontal axis represents the judgment ranking m described above or an average number according to the conventional average method. The vertical axis represents estimation throughput between the base station 110 and the terminals 121 to 124.

Simulation results 1801 to 1803 illustrated in FIG. 18 represent estimation throughput for a judgment ranking/average number in a case in which BPSK is used for wireless signals from the base station 110 to the terminals 121 to 124. BPSK stands for Binary Phase Shift Keying. Estimation throughput is normalized throughput to which SINR deterioration due to overhead in beam searching and reception characteristics, for example, is added. SINR stands for Signal to Interference and Noise Ratio.

Note that as simulation conditions, the number of the terminals 121 to 121M is 4 units (4-user multiplexing), and the terminals 121 to 124 are randomly arranged in a range of 90 degrees on circumference of a circle centering around the base station 110. Also suppose that the number of transmission antennae of the base station 110 is 32.

The simulation result 1801 represents estimation throughput for a judgment ranking/average number in a case in which there is no estimation error in receiving powers. In this case, the estimation throughput is fixed, irrespective of the judgment ranking/average number.

The simulation result 1802 represents estimation throughput for an average number in the average method wherein there is an estimation error in receiving powers, a plurality of receptions are performed as usual for each beam ID, and a beam ID with the highest average receiving power is made an estimation beam ID. In this case, the more the average number is, the more the number of transmissions of a searching beam for each beam ID increases. Thus, the estimation throughput is deteriorated due to increased overhead.

The simulation result 1803 represents estimation throughput for a judgment ranking m in a method wherein there is an estimation error in receiving powers and an estimation beam ID is derived based on rankings of receiving powers as with this embodiment. In this case, the lower the judgment ranking m is set, the better the estimation throughput becomes. For example, estimation throughput when the judgment ranking m=5 is better by approximately 2.5[%] than estimation throughput when the judgment ranking m=1.

(Other Example of Improvement of Estimation Throughput According to Embodiment 1)

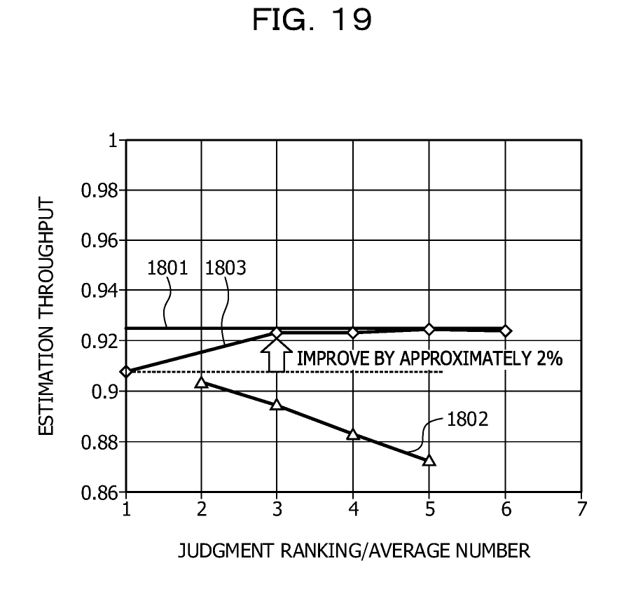

FIG. 19 is a diagram illustrating other example of the improvement in the estimation throughput according to Embodiment 1. In FIG. 19, same symbols are assigned to parts similar to the parts illustrated in FIG. 18 and a description is omitted. If 16QAM is used for wireless signals from the base station 110 to the terminals 121 to 124, simulation results 1801 to 1803 are as illustrated in FIG. 19. QAM stands for Quadrature Amplitude Modulation.

Also in the example illustrated in FIG. 19, in the simulation result 1803 according to the embodiment, the lower the judgment ranking m is set, the better the estimation throughput becomes. For example, estimation throughput when the judgment ranking m=3 is better by approximately 2[%] than estimation throughput when the judgment ranking m=1.

(Overhead Amount in Beam Searching According to Embodiment 1)

Here, an overhead amount in beam searching according to Embodiment 1 is described. For example, an overhead amount in wireless communications between the base station 110 and the terminal 121 may be expressed by the following expression (2).

$$Overhead amount = \frac{( {T}_{packet} + {T}_{margin} ) \times L + {T}_{gt}}{{T}_{bs}} \qquad ( 2 )$$

In the expression (2) above, T_{packet} is packet length of a beam searching packet (each length of the searching beams #1 to #L illustrated in FIG. 2, for example). T_{margin} is an interval of the beam searching packets (intervals of the searching beams #1 to #L illustrated in FIG. 2, for example). L is the number of azimuths at which searching beams are transmitted (L illustrated in FIG. 2, for example).

T_{gt} is guard time from the end of beam searching to start of data transmission (guard time provided between the beam searching period 211 and the data transmission period 212 or between the beam searching period 221 and the data transmission period 222, as illustrated in FIG. 2, for example). For example, T_{gt} includes delay in feedback or delay in beam control processing, for example. T_{bs} is a beam searching interval (beam searching cycles 210, 220 illustrated in FIG. 2, for example).

By way of example, suppose that T_{packet} is 4.43 [μs], T_{margin} is 3 [μs], L is 80, T_{gt} is 50 [μs], and T_{bs} is 45 [μs]. In this case, with the estimation method according to Embodiment 1, an overhead amount based on the expression (2) above is 1.43[%]. On the other hand, if the conventional average method is used, an overhead amount is 2.75[%] when the average number=2, 4.07[%] when the average number=3, 5.39[%] when the average number=4, and 6.71[%] when the average number=5. Thus, with the estimation method according to Embodiment 1, an overhead amount for estimation of an estimation beam ID may be reduced and estimation throughput may be improved.

(Degree of Dispersion of an Estimation Error in Receiving Power to SNR According to Embodiment 1)

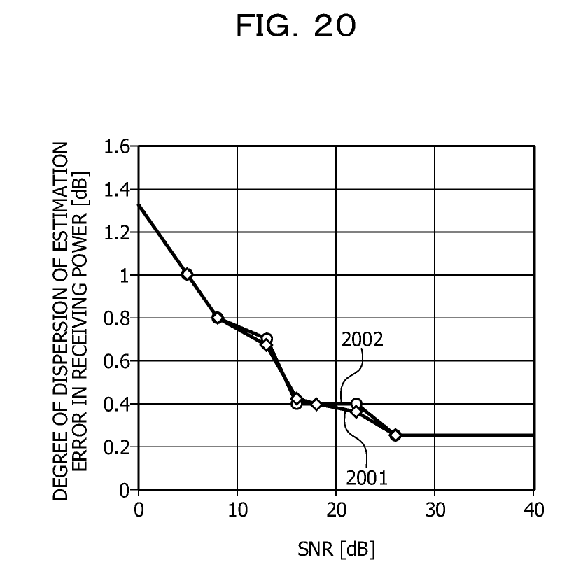

FIG. 20 is a diagram illustrating an example of a degree of dispersion of an estimation error in receiving power to SNR in Embodiment 1. In FIG. 20, the horizontal axis represents SNR [dB] and the vertical axis represents the degree of dispersion [dB] of an estimation error in receiving power.

A simulation result 2001 represents a simulation result of the degree of dispersion of an estimation error in receiving power to SNR. A tabulation result 2002 is a result of tabulation of the simulation result 2001. As illustrated in the simulation result 2001 and the tabulation result 2002, the lower SNR is, the larger the dispersion of the estimation error in the receiving power is (see FIG. 6, for example).

(Improvement in the SINR Characteristics According to Embodiment 1)

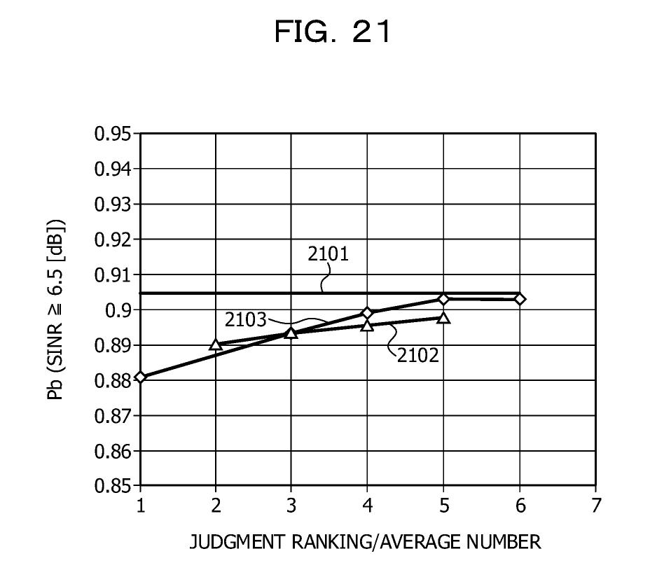

FIG. 21 is an example illustrating an example of improvement in SINR characteristics according Embodiment 1. In FIG. 21, the horizontal axis represents a judgment ranking m described above or an average number according to the conventional average method. The vertical axis represents the probability (Pb (SINR≧6.5 [dB])) that SINR between the base station 110 and the terminals 121 to 124 is 6.5 [dB] or higher.

Simulation results 2101 to 2103 illustrated in FIG. 21 represent SINR characteristics to a judgment ranking/average number in a case in which BPSK is used for wireless signals from the base station 110 to the terminals 121 to 124. Note that simulation conditions are similar to the simulation conditions illustrated in FIG. 18 or the like. The simulation result 2101 represents SINR characteristic to a judgment ranking/average number in a case in which there is no estimation error in receiving powers. In this case, the SINR characteristic is fixed irrespective of the judgment ranking/average number.

The simulation result 2102 represents SINR characteristic for an average number in the average method in which there is an estimation error in receiving power and multiple receptions are performed as usual for each beam ID and a beam ID with the highest average receiving power is made an estimation beam ID. The simulation result 2103 represents SINR characteristic for a judgment ranking m in a method wherein there is an estimation error in receiving powers and an estimation beam ID is derived based on rankings of receiving powers as with the embodiment.

As illustrated in the simulation result 2102 and the simulation result 2103, the conventional average method and the estimation method according to Embodiment 1 both have the effect of improving SINR. However, in the conventional average method, SINR is improved by increasing an average number, while SINR is improved by lowering the judgment ranking m with the estimation method according to Embodiment 1. Thus, with the estimation method according to Embodiment 1, SINR may be improved without transmitting a searching beam ID multiple times for each beam ID to take the average.

(Other Example of Improvement in SINR Characteristics According to Embodiment 1)

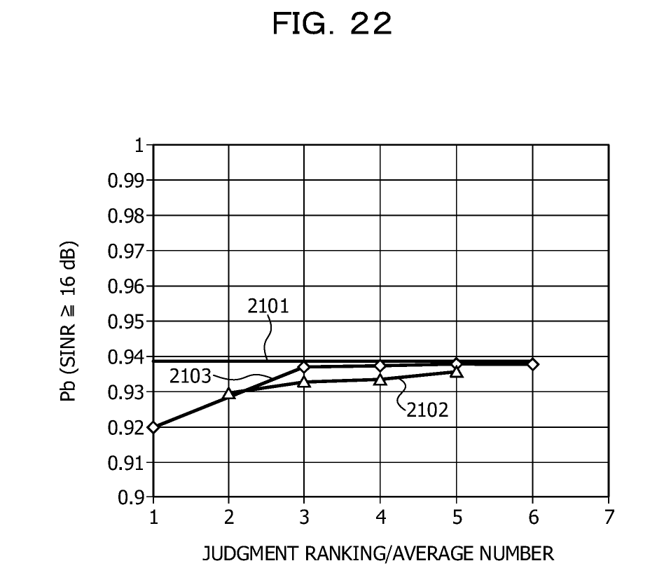

FIG. 22 is a diagram illustrating other example of the improvement in the SINR characteristics according to Embodiment 1. In FIG. 22, same symbols are assigned to parts similar to the parts illustrated in FIG. 21 and a description is omitted. For example, if 16QAM is used for wireless signals from the base station 110 to the terminals 121 to 124, the simulation results 2101 to 2103 are as illustrated in FIG. 22. Also in the example illustrated in FIG. 22, in the simulation result 2103 according to the embodiment, the lower the judgment ranking m is set, the better the SINR characteristic becomes.

(Countermeasure for an Exception by the Estimation Method According to Embodiment 1)

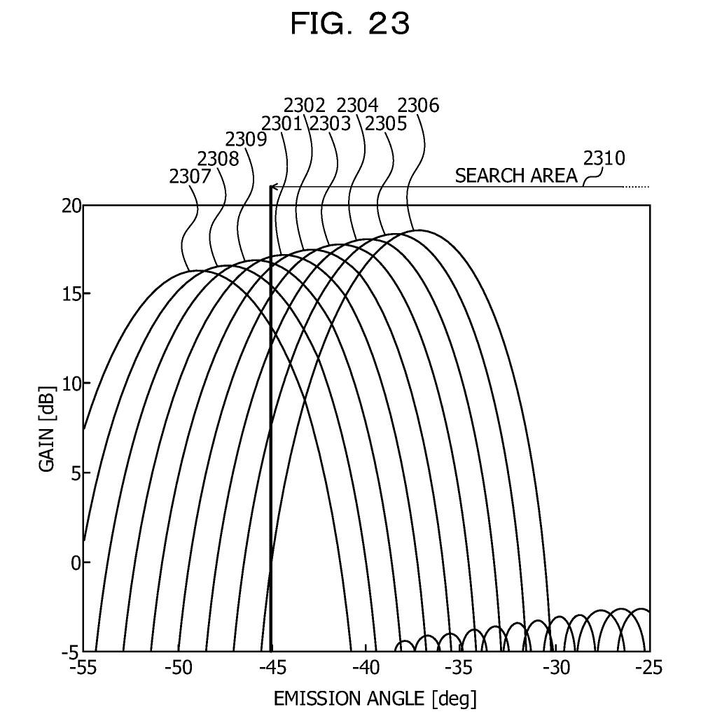

FIG. 23 is a diagram illustrating an example of a countermeasure for an exception by the estimation method according to Embodiment 1. In FIG. 23, the horizontal axis represents an emission angle [deg] of a searching beam transmitted by the base station 110, and the vertical axis represents gain [dB]. A search area 2310 is a range of an azimuth (emission angle) at which the base station 110 performs beam searching.

Beam patterns 2301 to 2306 whose center azimuths are included in the search area 2310 are, for example, beam patterns of searching beams respectively with beam IDs=1 to 6, of searching beams transmitted by the base station 110. Grating lobes 2307 to 2309 are grating lobes generated by searching beams with beam IDs=MaxID-2, MaxID-1, and MaxID in the neighborhood of the right end of the search area 2310, of the searching beams transmitted by the base station 110. The MaxID is the largest beam ID of the beam IDs of the searching beams transmitted by the base station 110, more specifically, the beam ID of the rightmost beam pattern in the search area 2310.

In addition, in the example illustrated in FIG. 23, an interval between an azimuth of a searching beam transmitted by the base station 110 and an azimuth of a grating lobe of the searching beam matches the size of the search area 2310. More specifically, a beam ID of a searching beam is circulated in a cycle of the size of the search area 2310.

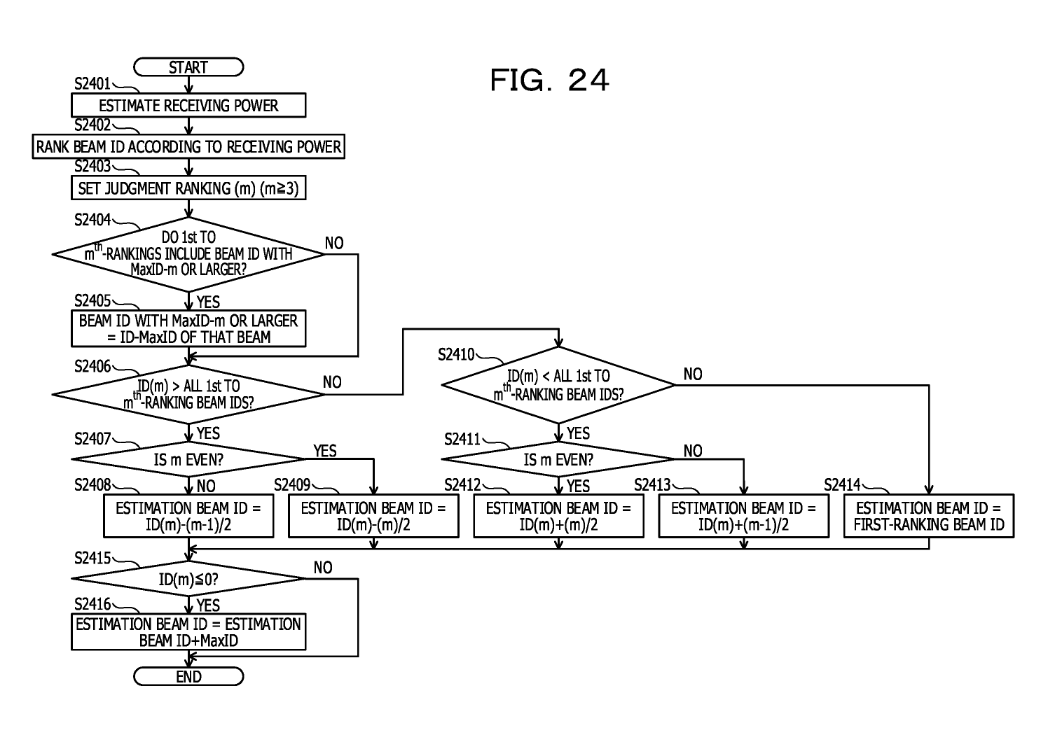

In FIG. 10, the configuration in which when the first-ranking to the m^{th}-ranking beam IDs include a beam ID of more than MaxID-m, the beam ID with the first-ranking receiving power is derived as the estimation beam ID is described. In contrast to this, as in FIG. 23, there is a case in which a beam ID of a searching beam is circulated in the cycle of the size of the search area 2310. In such a case, the terminal 121 may derive an estimation beam ID based on a magnitude relation of beam IDs even when the first-ranking to the m^{th}-ranking beam IDs include the beam ID of more than MaxID-m (see FIG. 24, for example).

(Azimuth Estimation Processing Including Exception Processing by the Terminal According to Embodiment 1)

FIG. 24 is a flow chart illustrating an example of azimuth estimation processing including exception processing by the terminal according to Embodiment 1. While the azimuth estimation processing by the terminal 121 is described, azimuth estimation processing by the terminals 122 to 12M is also similar. The terminal 121 may perform steps illustrated in FIG. 24, for example, as the azimuth estimation processing. Steps S2401 to S2403 illustrated in FIG. 24 are similar to steps S1001 to S1003 illustrated in FIG. 10.

Following step S2403, the terminal 121 determines whether or not beam IDs with the first-ranking to the m^{th}-ranking receiving powers include a beam ID of MaxID-m or higher (step S2404). The MaxID is the maximum value of a beam ID to be used by the base station 110 to transmit a searching beam, and is a beam ID corresponding to the largest azimuth of azimuths used by the base station 110 to transmit a searching beam. If the beam IDs with the first-ranking to the m^{th}-ranking receiving powers do not include the beam ID of MaxID-m or higher (step S2404: No), the terminal 121 proceeds to step S2406.

In step S2404, when the beam IDs with the first-ranking to the m^{th}-ranking receiving powers include the beam ID of MaxID-m or larger (step S2404: Yes), the terminal 121 proceeds to step S2405. More specifically, the terminal 121 replaces the beam ID of MaxID-m or larger of the first-ranking to the m^{th}-ranking beam IDs with a beam ID resulting from subtraction of MaxID from that beam ID (step S2405).

Then, the terminal 121 proceeds to step S2406. Steps S2406 to S2414 illustrated in FIG. 24 are similar to steps S1004 to S1012 illustrated in FIG. 10. However, the terminal 121 proceeds to step S2415 following steps S2408, S2409, S2412, S2413, and S2414. More specifically, the terminal 121 determines whether or not ID(m)≦0 (step S2415). More specifically, the terminal 121 determines whether or not ID correction in step S2404 is done on ID(m).

In step S2415, when ID(m) is not 0 (step S2415: No), the terminal 121 finishes a series of the azimuth estimation processing. When ID(m)≦0 (step S2415: Yes), the terminal 121 sets an estimation beam ID=estimation beam ID+MaxID (step S2416), and finishes a series of the azimuth estimation processing.

If ID(m) after ID correction is used in derivation of an estimation beam ID in step S2416, a correct estimation beam ID may be obtained by adding the MaxID subtracted in the ID correction to the estimation ID. With the processing illustrated in FIG. 24, even if the terminal 121 is located in the neighborhood of an end of a target range of beam searching of the base station 110, an estimation beam ID may be derived with precision.

As illustrated in FIGS. 23 and 24, when the first-ranking to the m^{th}-ranking beam IDs include the beam ID of MaxID-m or larger, an estimation beam ID may be temporarily calculated after MaxID is subtracted from that beam ID. Then, if MaxID is subtracted from the m^{th}-ranking beam ID, a correct estimation beam ID may be calculated by adding MaxID to the temporarily calculated estimation beam ID. With this, even when the user is located in the neighborhood of the end of the target range of beam searching, an estimation beam ID may be derived with precision.

Thus, with Embodiment 1, ranking that sets rankings of respective directions of a plurality of beams in descending order of beam receiving powers may be performed, based on receiving powers of the plurality of beams received in the terminal. Then, an estimated direction of a beam with the largest receiving power may be calculated based on a result of comparison of a direction of a predetermined ranking at which receiving power is ranked third or lower with each azimuth with the receiving power ranking being higher than the predetermined ranking. With this, any influence of an estimation error in receiving powers may be controlled and a user direction may be estimated with precision.

In addition, the predetermined ranking may be a ranking of a beam with the reception quality being higher than predetermined quality. With this, a beam estimated direction with the highest receiving power may be determined by excluding a direction having a high beam error rate and being less reliable. Thus, a user direction may be estimated with precision.

In addition, the predetermined ranking may be the lowest ranking among the rankings of beams having the reception quality higher than the predetermined quality. With this, a direction having the high beam error rate and being less reliable may be excluded and a beam estimated direction of a beam with the largest power reception may be calculated relative to a direction in which changing of rankings of receiving powers due to an estimation error in the receiving powers is most unlikely to occur. Thus, a user direction may be estimated with precision.

In addition, for example, each beam is associated with an identifier having size corresponding to a direction of that beam. For example, each searching beam described above is associated with a beam ID whose numeric value is larger as the azimuth illustrated in FIG. 8 is larger. In this case, a beam estimated direction with the largest receiving power may be calculated based on a magnitude relation between the beam identifier in the predetermined ranking and each identifier of each beam higher than the predetermined ranking. Note that a configuration may be such that each searching beam is associated with a beam ID whose numeric value is smaller as an azimuth is larger.

### Embodiment 2

For Embodiment 2, parts that differ from Embodiment 1 are described. While in Embodiment 1, the configuration in which a beam azimuth of the base station 110 is one direction, more specifically, two-dimensionally variable is described, a configuration in which beam azimuths of the base station 110 are two directions, more specifically, three-dimensionally variable is described in Embodiment 2.

(Beam Searching According to Embodiment 2)

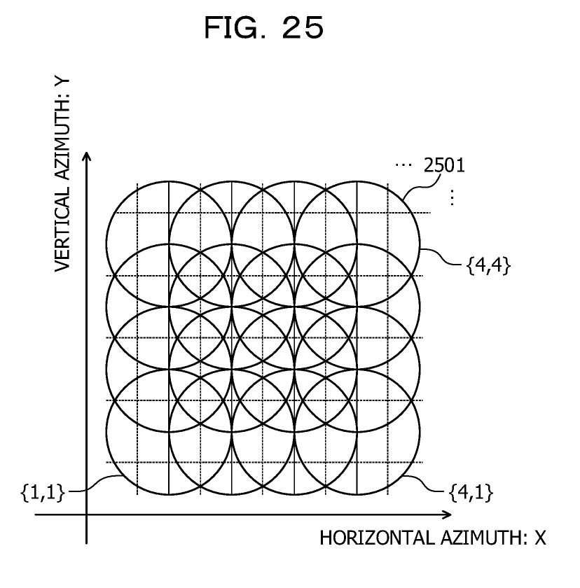

FIG. 25 is a diagram illustrating an example of beam searching according to Embodiment 2. Beam patterns 2501 illustrated in FIG. 25 is beam patterns of azimuths available to the base station 110. As illustrated in FIG. 25, when beam azimuths from a base station 110 to terminals 121 to 12M are three-dimensionally variable, the base station 110 performs beam searching in two directions of a horizontal azimuth (horizontal direction) and a vertical azimuth (vertical direction), for example.

For example, the base station 110 transmits searching beams of a division number (Nx) of the horizontal azimuth x a division number (Ny) of the vertical azimuth. In the example illustrated in FIG. 25, while Nx=Ny=4, each of Nx and Ny may be any number of 2 or larger.

Each of IDs of the beam patterns 2501 may be expressed like {IDx(i), IDy(j)}. IDx(i) is a beam ID of the horizontal azimuth (1≦i≦Nx). IDy(j) is a beam ID of the vertical azimuth (1≦j≦Ny).

For example, a beam ID of the lowest left beam pattern 2501 in FIG. 25 may be expressed like {1, 1}. In addition, a beam ID of the lowest right beam pattern 2501 in FIG. 25 may be expressed like {4, 1}. In addition, a beam ID of the highest right beam pattern 2501 in FIG. 25 may be expressed like {4, 4}.

Each of the terminals 121 to 12M calculates receiving powers of searching beams of the division number of the horizontal azimuth (Nx) x the division number of the vertical azimuth (Ny)=RxPow {IDx(i), IDy(i)}, and determines an estimation beam ID based on the calculated receiving powers.

(Transmission Processing of a Searching Beam from the Base Station According to Embodiment 2)

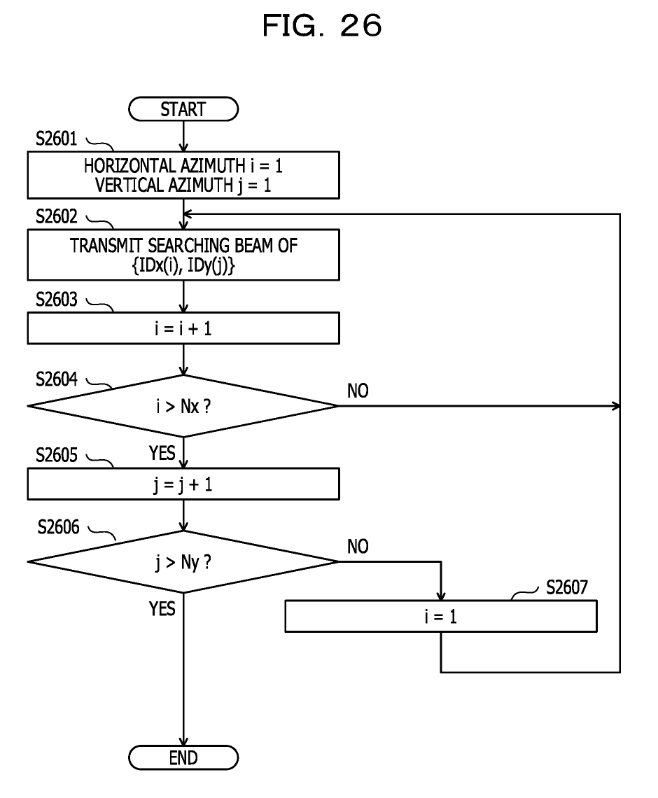

FIG. 26 is a flow chart illustrating an example of transmission processing of a searching beam from the base station according to Embodiment 2. The base station 110 according to Embodiment 2 performs steps illustrated in FIG. 26, for example, as the transmission processing of a searching beam.

First, the base station 110 sets the horizontal azimuth i and the vertical azimuth j to 1 (step S2601). Then, the base station 110 transmits searching beams of beam IDs={IDx(i), IDy(J)} based on the current horizontal azimuth i and vertical azimuth j (step S2602).

Then, the base station 110 increments the horizontal azimuth i (i=i+1) (step S2603). Then, the base station 110 determines whether or not the horizontal azimuth i exceeds Nx (step S2604). When the horizontal azimuth i does not exceed Nx (step S2604: No), the base station 110 returns to step S2602.

In step S2604, when the horizontal azimuth exceeds Nx (step S2604: Yes), the base station 110 increments the vertical azimuth (j=j+1) (step S2605). Then, the base station 110 determines whether or not the vertical azimuth j exceeds Ny (step S2606). When the vertical azimuth j does not exceed Ny (step S2606: No), the base station 110 returns the horizontal azimuth i to 1 (step S2607), and returns to step S2602.

In step S2606, when the vertical azimuth j exceeds Ny (step S2606: Yes), the base station 110 finishes a series of processing. With the steps illustrated in FIG. 26, the base station 110 may transmit searching beams of azimuths in Nx×Ny ways. After this, the base station 110 receives feedback signals from the terminals 121 to 12M.

(Azimuth Estimation Processing by the Terminal According to Embodiment 2)

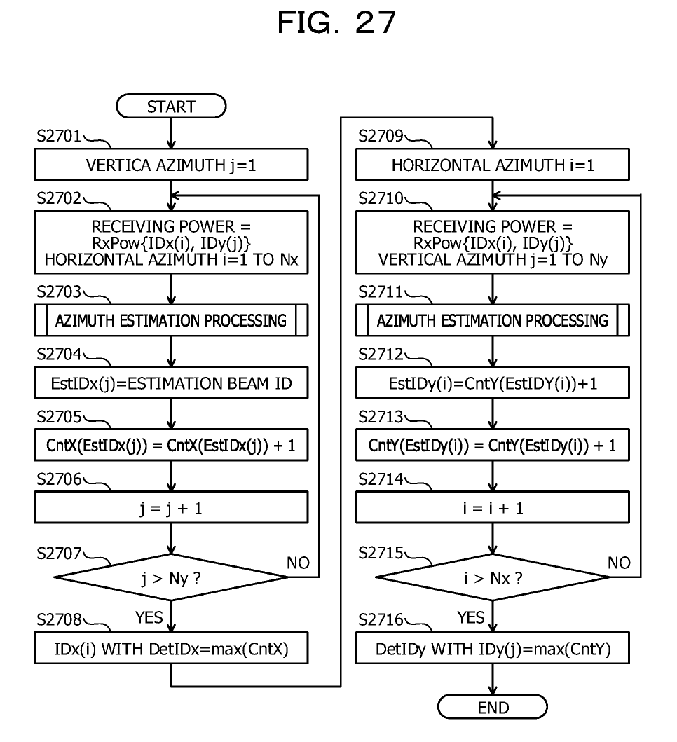

FIG. 27 is a flow chart illustrating an example of azimuth estimation processing by the terminal according to Embodiment 2. While the azimuth estimation processing by the terminal 121 is described, the azimuth estimation processing by the terminals 122 to 12M is similar. After receiving the searching beams in the Nx×Ny ways that are transmitted from the base station 110 with the steps illustrated in FIG. 26, for example, the terminal 121 performs steps illustrated in FIG. 27, for example, as the azimuth estimation processing.

First, the terminal 121 sets the vertical azimuth j to 1 (step S2701). Then, the terminal 121 estimates receiving powers of the received searching beams=RxPow {IDx(i), IDy(j)}, while changing the horizontal azimuth i to 1 to Nx (step S2702).

Then, the terminal 121 performs the azimuth estimation processing based on the receiving power=RxPow {IDx(i), ID(j)} estimated in step S2702 (step S2703). The azimuth estimation processing in step S2703 may be azimuth estimation processing similar to steps S1002 to 1012 illustrated in FIG. 10, for example. In this case, in step S1002, the terminal 121 rankings the beam IDs={IDx(i), IDy(j)} according to the receiving powers=RxPow {IDx(i), IDy(j)} estimated in step S2702. In addition, the azimuth estimation processing in step S2703 may be the estimation processing similar to steps S2402 to S2416 illustrated in FIG. 24.

Then, the terminal 121 holds the estimation beam ID obtained through the estimation processing in step S2703 as EstIDx(j) (step S2704). Then, the terminal 121 increments the counter CntX (EstIDx(j)) (step S2705). The counter CntX (EstIDx(j)) is a counter that counts estimation candidates of the horizontal azimuth. An initial value of the counter CntX (EstIDx(j)) is 0.

Then, the terminal 121 increments the vertical azimuth j (j=j+1) (step S2706). Then, the terminal 121 determines whether or not j exceeds Ny (step S2707). When j does not exceed Ny (step S2707: No), the terminal 121 returns to step S2702.

In step S2707, when j exceeds Ny (step S2707: Yes), the terminal 121 holds IDx(i) which becomes max (CntX), as an estimation result DetIDx of a beam ID of the horizontal azimuth (step S2708). More specifically, the terminal 121 holds, as the estimation result DetIDx of the beam ID of the horizontal azimuth, the mode of the estimation IDs of beam IDs of the horizontal azimuths that are obtained by changing the vertical azimuth j to 1 to Ny.

Then, the terminal 121 sets the horizontal azimuth i to 1 (step S2709). Then, the terminal 121 estimates the receiving powers of the received searching beams=RxPow {IDx(i), IDy(j)} while changing the vertical azimuth j to 1 to Ny (step S2710). Note that the receiving powers estimated in steps S2701 to S2707 may be used for estimation in step S2710.

Then, the terminal 121 performs the azimuth estimation processing based on the receiving powers=RxPow {IDx(i), IDy(j)} estimated in step S2710 (step S2711). Then, the terminal 121 holds the estimation ID obtained through the estimation processing in step S2711 as EstIDy(i) (step S2712).

Then, the terminal 121 increments a counter CntY (EstIDy(i)) (step S2713). The counter CntY (EstIDy(i)) is a counter that counts estimation candidates of the vertical azimuth. An initial value of the counter CntY (EstIDy(i)) is 0.

Then, the terminal 121 increments the horizontal azimuth i (i=i+1) (step S2714). Then, the terminal 121 determines whether or not i exceeds Nx (step S2715). When i does not exceed Nx (step S2715: No), the terminal 121 returns to step S2710.

In step S2715, when i exceeds Nx (step S2715: Yes), the terminal 121 holds IDy(j) that becomes max (CntY) as an estimation result DetIDy of a beam ID of the vertical azimuth (step S2716) and finishes a series of processing. More specifically, the terminal 121 holds, as the estimation result DetIDy of the beam ID of the vertical azimuth, the mode of the estimation IDs of beam IDs of the vertical azimuths that are obtained by changing the horizontal azimuth i to 1 to Ny.

This allows the terminal 121 to obtain the estimation result DetIDx of the beam ID of the horizontal azimuth that is held in step S2708 and the estimation result DetIDy of the beam ID of the vertical azimuth that is retained in step S2716. The terminal 121 transmits to the base station 110 a feedback signal that includes the obtained estimation results DetIDx, DetIDy as the estimation beam ID.

Thus, with Embodiment 2, even in a case where beams are beams that have different combinations of a first direction (horizontal azimuth, for example) and a second direction (vertical azimuth, for example) from each other, a user direction may be determined with precision.

For example, based on each of beams having the same second direction but having the different first directions, an estimated direction with the estimation method described above may be calculated for the second direction of the each beam, and an estimated direction of the first direction based on the calculation result may be calculated. In addition, based on each of beams having the same first direction but having the different second directions, an estimated direction with the estimation method described above may be calculated for the first direction of the each beam, and an estimated direction of the second direction based on the calculation result may be calculated. This enables calculation of the estimated direction of the first direction and the estimated direction of the second direction. Thus, a user direction may be estimated with precision.

In addition, in Embodiment 2, as illustrated in FIGS. 16 and 17, a configuration may be such that for example, estimation of a user direction based on an estimation value of receiving power for each beam ID is performed in the base station 110. In addition, in Embodiment 2, estimation of a user direction including the countermeasure for an exception illustrated in FIGS. 23 and 24, for example, may also be performed.

### Embodiment 3

For Embodiment 3, parts that differ from Embodiments 1 and 2 are described. Embodiment 3 describes a configuration in which an estimation beam ID obtained with the estimation methods in Embodiments 1 and 2 is corrected depending on the situation.

(Beam Azimuth Estimation Unit of a Terminal According to Embodiment 3)

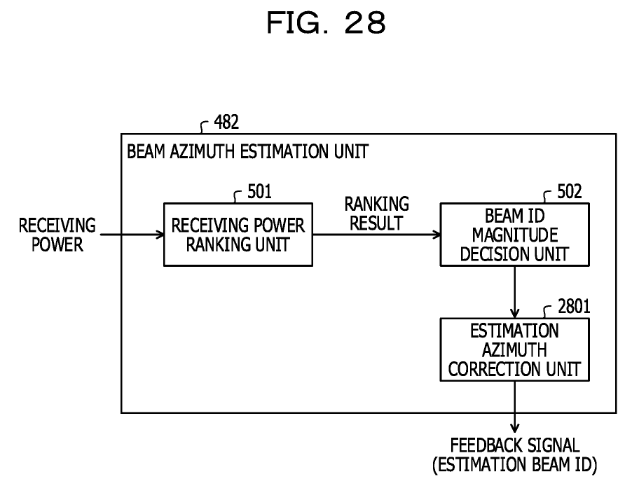

FIG. 28 is a diagram illustrating an example of a beam azimuth estimation unit of a terminal according to an embodiment 3. In FIG. 28, same symbols are assigned to parts similar to the parts illustrated in FIG. 5 and a description is omitted. As illustrated in FIG. 28, a beam azimuth estimation unit 482 of a terminal 121 according to Embodiment 3 includes an estimation azimuth correction unit 2801, in addition to the configuration illustrated in FIG. 5.

The beam ID magnitude decision unit 502 outputs a determined estimation beam ID to the estimation azimuth correction unit 2801. The beam ID magnitude decision unit 502 also outputs to the estimation azimuth correction unit 2801 receiving power of each beam ID and a ranking result, as well as area information indicating in which of the first area 811 and the second area 812 the terminal 121 is located, or the like.

The estimation azimuth correction unit 2801 performs estimation azimuth correction processing that corrects an estimation beam ID output from the beam ID magnitude decision unit 502 based on the information output from the beam ID magnitude decision unit 502. Then, the estimation azimuth correction unit 2801 outputs a feedback signal indicating an estimation beam ID on which the estimation azimuth correction processing is performed.

(Azimuth to be Judged in the Estimation Azimuth Correction by the Terminal According to Embodiment 3)

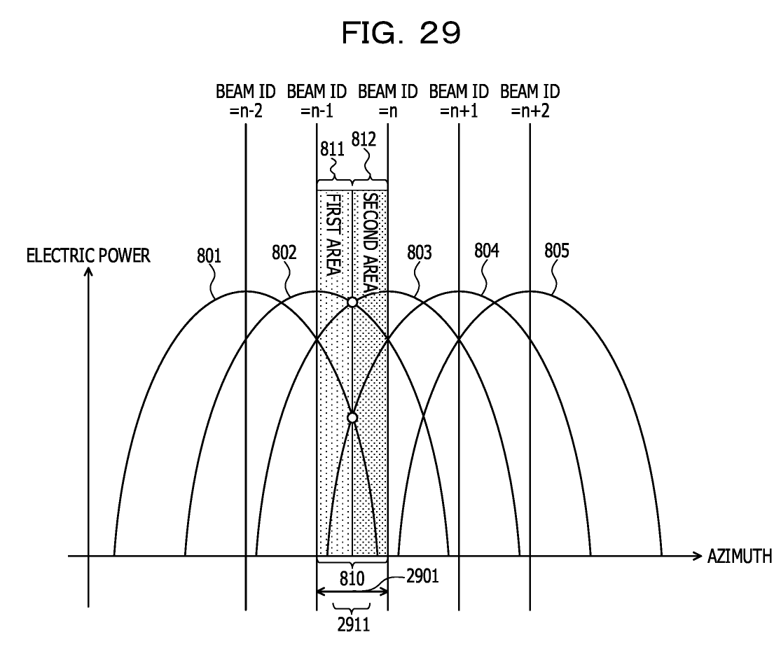

FIG. 29 is a diagram illustrating an example of azimuth to be judged in estimation azimuth correction by the terminal according to Embodiment 3. In FIG. 29, same symbols are assigned to parts similar to the parts illustrated in FIG. 8 and a description is omitted. A beam azimuth interval 2901 illustrated in FIG. 29 is an interval of intermediate azimuths of the beam patterns 801 to 805.

In the neighborhood of a midpoint of the beam azimuth interval 2901, a difference in receiving power between continuous rankings is small. For example, in the neighborhood of a boundary between the first area 811 and the second area 812, a difference between receiving powers of the first-ranking and the second-ranking beam patterns 802, 803 is close to 0, and a difference between receiving powers of the third-ranking and the fourth-ranking beam patterns 801, 804 is close to 0.

Therefore, when a difference between continuously-ranking receiving powers is small, it may be determined that the terminal 121 is located in the neighborhood of the midpoint of the beam azimuth interval 2901. The estimation azimuth correction unit 2801 illustrated in FIG. 28 takes advantage of this to perform estimation azimuth correction processing that corrects the estimation beam ID obtained by the beam ID magnitude decision unit 502.

For example, when a difference between continuously-ranking receiving powers is small, the estimation azimuth correction unit 2801 determines that the terminal 121 is located in an area 2911, for example. The estimation azimuth correction unit 2801 is an area where a midpoint between the beam patterns 802, 803 at the beam azimuth interval 2901 is a midpoint of its own, and an interval is smaller than the beam azimuth interval 2901 (half of the beam azimuth interval 2901, for example).

For example, the estimation azimuth correction unit 2801 makes a beam ID (for example, n−0.5) indicating a middle of a beam ID=n−1 of the beam pattern 802 and a beam ID=n of the beam pattern 803 an estimation beam ID after correction.

This makes it possible to determine with precision a beam ID (beam azimuth) with the receiving power of the terminal 121 increasing, while controlling an increase in an amount of calculation.

(Electric Power Difference Between Continuous Rankings to an Azimuth in a Communication System According to Embodiment 3)

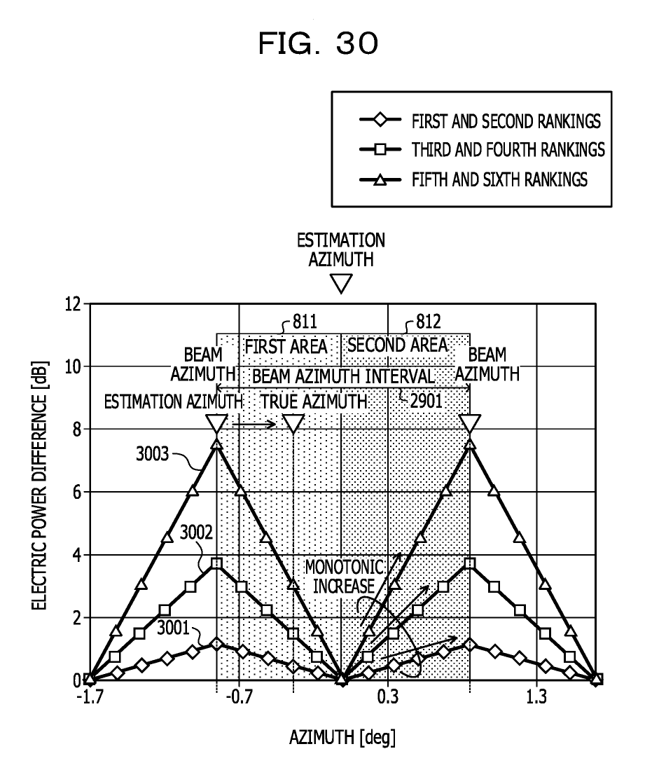

FIG. 30 is a diagram illustrating an example of an electric power difference between continuous rankings to an azimuth in a communication system according to Embodiment 3. In FIG. 30, same symbols are assigned to parts similar to the parts illustrated in FIG. 29 and a description is omitted. In addition, in FIG. 30, the horizontal axis represents an azimuth [deg] and the vertical axis represents an electric power difference between beam IDs.

An electric power difference characteristic 3001 illustrated in FIG. 30 represents a characteristic to an azimuth of an electric power difference between the first-ranking receiving power and the second-ranking receiving power. An electric power difference characteristic 3002 represents a characteristic to an azimuth of an electric power difference between the third-ranking receiving power and the fourth-ranking receiving power. An electric power difference characteristic 3003 represents a characteristic to an azimuth of an electric power difference between the fifth-ranking receiving power and the sixth-ranking receiving power.

As illustrated in the electric power difference characteristics 3001 to 3003, an electric power difference between the continuously-ranking receiving powers is close to 0 in the neighborhood of the boundary between the first area 811 and the second area 812, more specifically, in the neighborhood of the midpoint of the beam azimuth interval 2901. In addition, an electric power difference between the continuously-ranking receiving power monotonically increases to the azimuth with the midpoint of the beam azimuth interval 2901 as 0.

(Estimation Azimuth Correction by the Terminal According to Embodiment 3)

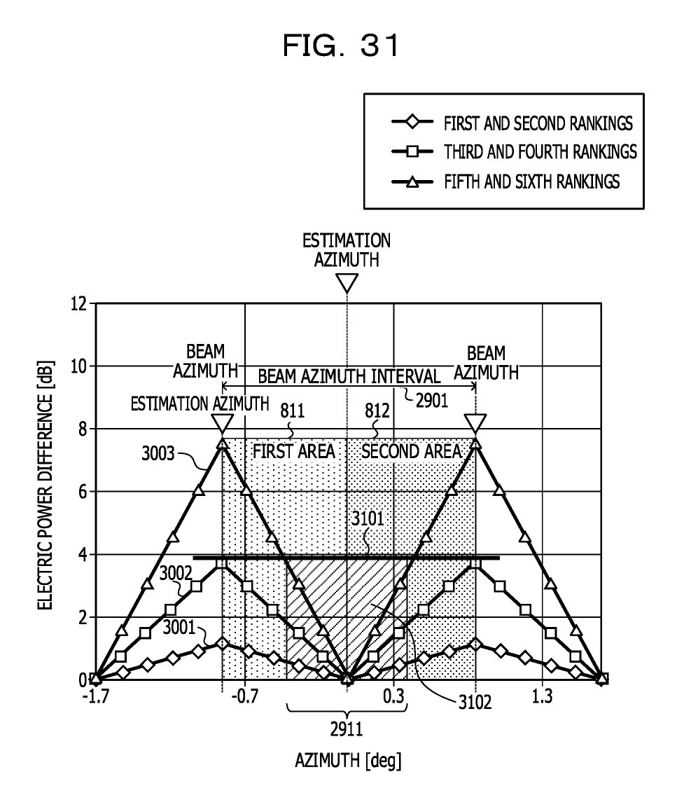

FIG. 31 is a diagram illustrating an example of the estimation azimuth correction by the terminal according to Embodiment 3. In FIG. 31, same symbols are assigned to parts similar to the parts illustrated in FIG. 30 and a description is omitted. For example, when an electric power difference between the fifth-ranking receiving power and the sixth-ranking receiving power, which is indicated by the electric power difference characteristic 3003, falls below a predetermined threshold 3101, the terminal 121 performs correction according to a beam azimuth illustrated by the estimation beam ID before correction.

The threshold 3101 may be an intermediate value (half of the maximum value) of the electric power difference between the fifth-ranking receiving power and the sixth-ranking receiving power. In the example illustrated in FIG. 31, the threshold may be 3.76, for example.

When the electric power difference between the fifth-ranking receiving power and the sixth-ranking receiving power falls below the threshold 3101 (in the case of an area 3102), the terminal 121 makes the midpoint of the area 2911 an estimation azimuth. In this case, the terminal 121 corrects an estimation beam ID to a beam ID indicating the midpoint of the area 2911.

(Azimuth Estimation Processing According to Embodiment 3)

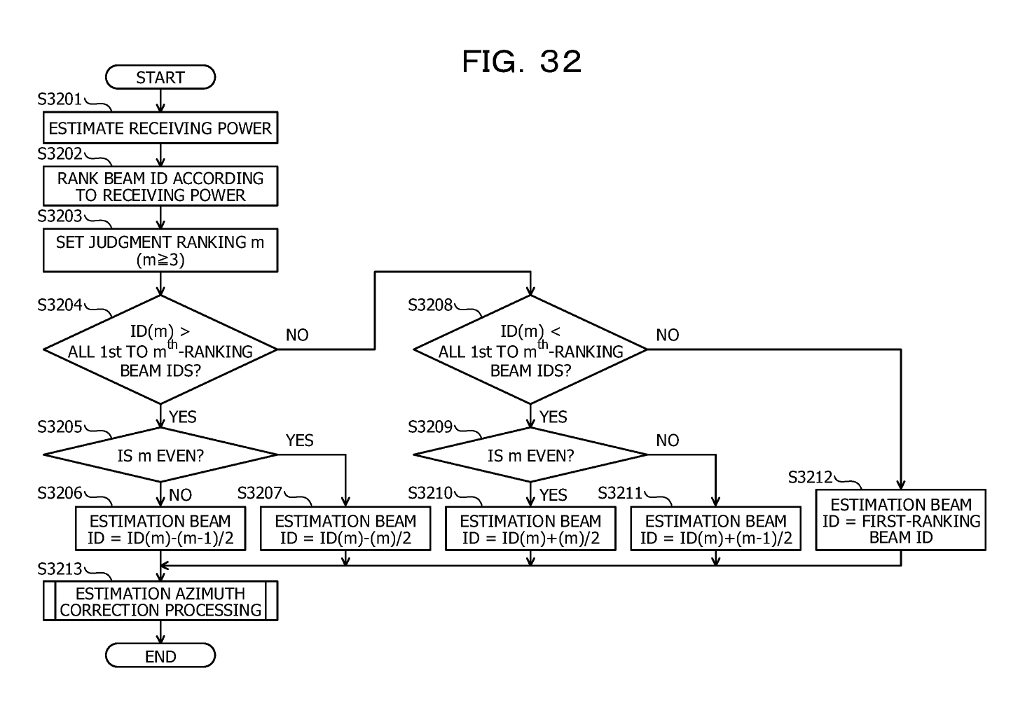

FIG. 32 is a flow chart illustrating an example of azimuth estimation processing by the terminal according to Embodiment 3. While azimuth estimation processing by the terminal 121 is described, azimuth estimation processing by the terminals 122 to 12M is also similar. The terminal 121 performs steps illustrated in FIG. 32, for example, as the azimuth estimation processing.

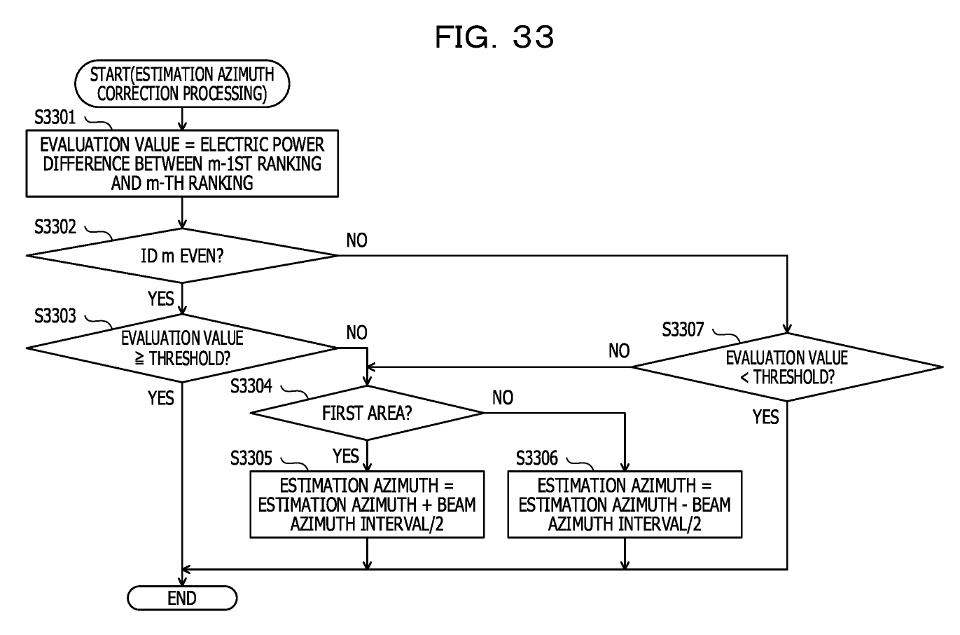

Steps S3201 to S3212 illustrated in FIG. 32 are similar to steps S1001 to S1012 illustrated in FIG. 10. However, following the steps S3206, S3207, S3210, S3211, and S3212, the terminal 121 proceeds to step S3213. More specifically, the terminal 121 performs estimation azimuth correction processing that corrects an estimation beam ID obtained through steps S3206, S3207, S3210, S3211, and S3212 (step S3213), and finishes a series of the azimuth estimation processing. The estimation azimuth correction processing in step S3213 is described below (see FIG. 33, for example).

(Estimation Azimuth Correction Processing by the Terminal According to Embodiment 3)

FIG. 33 is a flow chart illustrating an example of estimation azimuth correction processing by the terminal according to Embodiment 3. For example, in step S3213 illustrated in FIG. 32, the terminal 121 performs steps illustrated in FIG. 33, for example, as estimation azimuth correction processing. The steps illustrated in FIG. 33 are performed by the estimation azimuth correction unit 2801 illustrated in FIG. 28, for example.

First, the terminal 121 calculates an electric power difference between receiving power of the m−1^{th}-ranking beam ID and receiving power of the m^{th}-ranking beam ID as an evaluation value in the estimation azimuth correction processing (step S3301). m in the estimation azimuth correction processing is a value of 2 or larger, for example, and may differ from m in the azimuth estimation processing of FIG. 10 or the like.

Then, the terminal 121 determines whether or not a judgment ranking m is an even (step S3302). When the judgment ranking m is an even (step S3302: Yes), the terminal 121 determines whether or not the evaluation value calculated in step S3301 is a predetermined threshold or larger (step S3303).

In step S3303, when the evaluation value is the threshold or larger (S3303: Yes), the terminal 121 finishes a series of the estimation azimuth correction processing without correcting the estimation beam ID. When the evaluation value is less than the threshold (step S3303: No), the terminal 121 determines whether or not the terminal 121 is located in the first area 811 (step S3304).

In step S3304, when the terminal 121 is located in the first area 811 (step S3304: Yes), the terminal 121 proceeds to step S3305. More specifically, the terminal 121 performs correction to add a beam azimuth interval/2 to the beam azimuth indicated by the estimation beam ID before correction (step S3305) and finishes a series of the estimation azimuth correction processing. In this case, the terminal 121 obtains the beam ID to which the beam azimuth interval/2 is added, as the estimation beam ID after the correction. The beam azimuth interval is size of the beam azimuth interval 2901 illustrated in FIG. 29, for example.

In step S3304, when the terminal 121 is located in the second area 812 (step S3304: No), the terminal 121 proceeds to step S3306. More specifically, the terminal 121 performs correction to subtract the beam azimuth interval/2 from the beam azimuth indicated by the estimation beam ID before correction (step S3306) and finishes a series of the estimation azimuth correction processing. In this case, the terminal 121 obtains the beam ID indicating the beam azimuth from which the beam azimuth interval/2 is subtracted, as the estimation ID beam after the correction.

In step S3302, when the judgment ranking m is not an even (step S3302: No), the terminal 121 determines whether or not the evaluation value calculated in step S3301 is less than the predetermined threshold (step S3307).

In step S3307, when the evaluation value is less than the threshold (step S3307: Yes), the terminal 121 finishes a series of the estimation azimuth correction processing without correcting the estimation beam ID. When the evaluation value is the threshold value or larger (step S3307: No), the terminal 121 proceeds to step S3304 and corrects the estimation beam ID.

(Other Example of Estimation Azimuth Correction by the Terminal According to Embodiment 3)

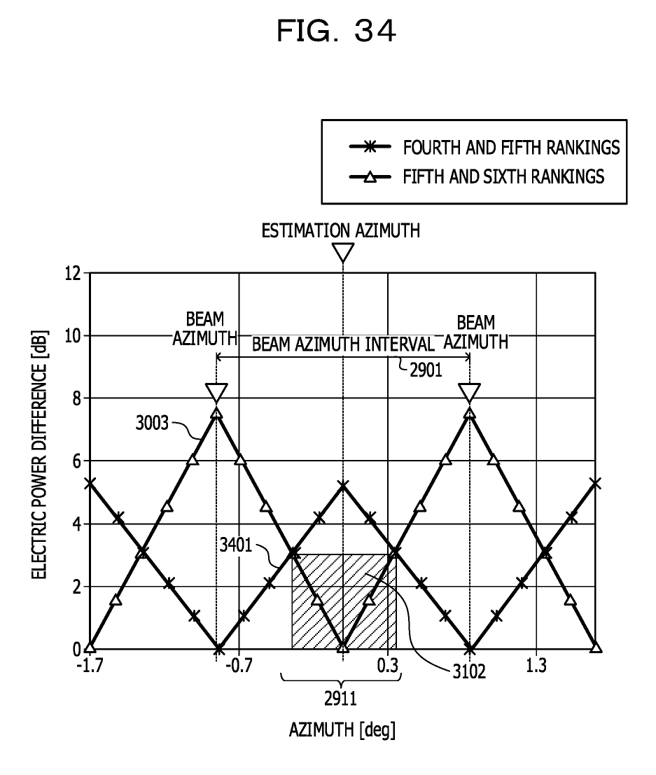

FIG. 34 is a diagram illustrating other example of the estimation azimuth correction by the terminal according to Embodiment 3. In FIG. 34, same symbols are assigned to parts similar to the parts illustrated in FIG. 31 and a description is omitted. An electric power difference characteristic 3401 illustrated in FIG. 34 refers to a characteristic to an azimuth of an electric power difference between the fourth-ranking receiving power and the fifth-ranking receiving power.

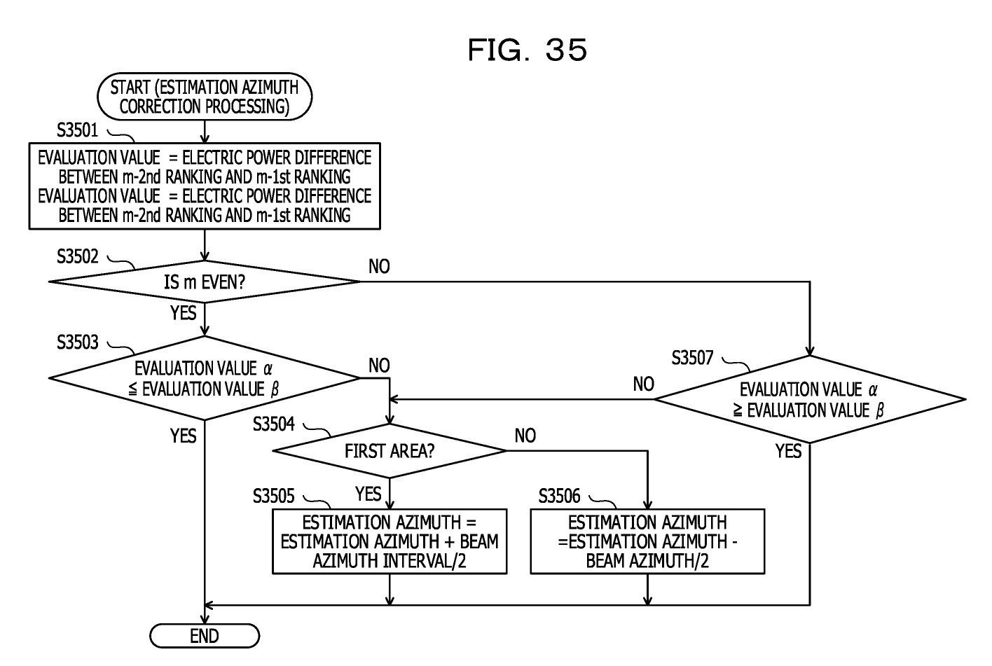

The terminal 121 may use the electric power difference characteristic 3003 between the fifth-ranking receiving power and the sixth-ranking receiving power and the electric power difference characteristic 3401 between the fourth-ranking receiving power and the fifth-ranking receiving power to perform estimation azimuth correction processing. In this case, the terminal 121 may perform the estimation azimuth correction processing even without using the above-mentioned threshold 3101. Thus, the estimation azimuth correction processing may be performed without relying on the electric power difference between the fifth-ranking receiving power and the sixth-ranking receiving power, or the like, to determine the threshold 3101, for example (see FIG. 35, for example).

(Other Example of Estimation Azimuth Correction Processing by the Terminal According to Embodiment 3)

FIG. 35 is a flowchart illustrating other example of the estimation azimuth correction processing by the terminal according to Embodiment 3. For example, in step S3213 illustrated in FIG. 32, the terminal 121 may perform steps illustrated in FIG. 35, for example, as the estimation azimuth correction processing. The steps illustrated in FIG. 35 are performed by the estimation azimuth correction unit 2801 illustrated in FIG. 28, for example.

First, the terminal 121 calculates an electric power difference between receiving power of the m−2^{th}-ranking beam ID and receiving power of the m−1^{th}-ranking beam ID as an evaluation value α. The terminal 121 also calculates an electric power difference between the receiving power of the m−1^{th}-ranking beam ID and receiving power of the m^{th}-ranking beam ID as an evaluation value β (step S3501). This allows the evaluation values α, β in the estimation azimuth correction processing to be obtained.

Then, the terminal 121 determines whether or not the judgment ranking m is an even (step S3502). When the judgment ranking m is an even (step S3502: Yes), the terminal 121 determines whether or not the evaluation value α is the evaluation value β or lower, based on the evaluation values α, β calculated in step S3501 (step S3503).

In step S3503, when the evaluation value α is the evaluation value β or lower (step S3503: Yes), the terminal 121 finishes a series of the estimation azimuth correction processing without correcting the estimation beam ID. When the evaluation value α is not the evaluation value β or lower (step S3503: No), the terminal 121 proceeds to step S3504. Steps S3504 to S3506 illustrated in FIG. 35 are similar to steps S3304 to S3306 illustrated in FIG. 33.

In step S3502, when the judgment ranking m is not an even (step S3502: No), the terminal 121 determines whether or not the evaluation value α is the evaluation value β or larger, based on the evaluation values α, β calculated in step S3501 (step S3507).

In step S3507, when the evaluation value α is the evaluation value β or larger (step S3507: Yes), the terminal 121 finishes a series of the estimation azimuth correction processing without correcting the estimation beam ID. When the evaluation value α is less than the evaluation value β (step S3507: No), the terminal 121 proceeds to step S3504 to correct the estimation beam ID.

(Derivation of an Estimation Beam ID by the Terminal According to Embodiment 3)

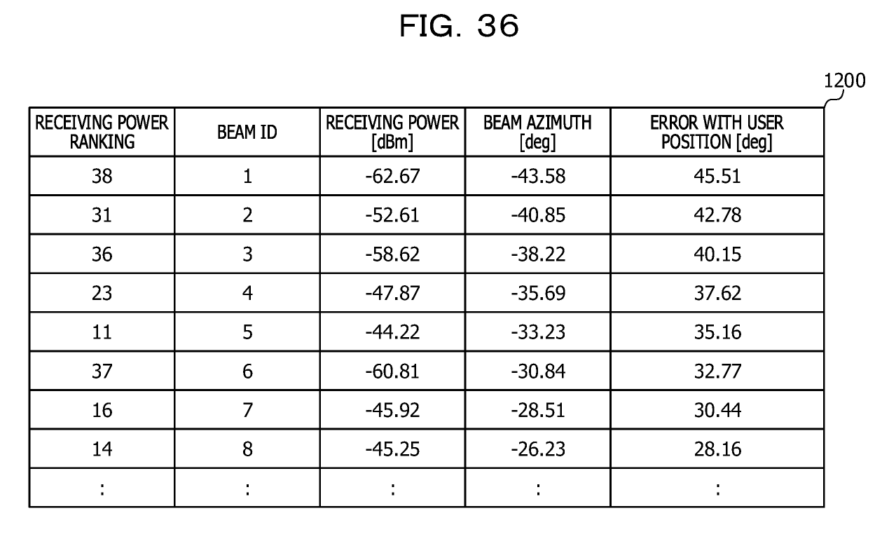

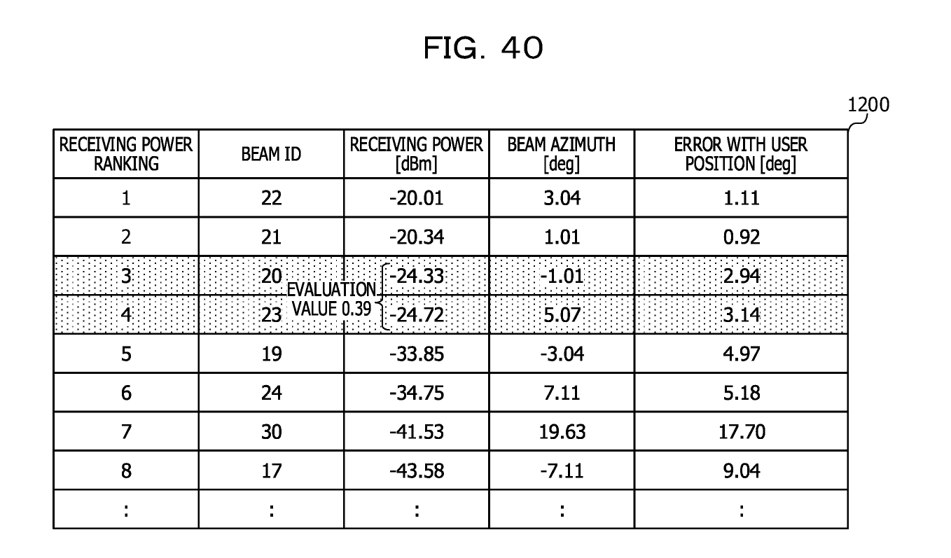

FIGS. 36 to 40 are diagrams illustrating an example of derivation of an estimation beam ID by the terminal according to Embodiment 3. In FIGS. 36 to 40, a description of parts similar to the parts illustrated in FIGS. 12 to 15 is omitted. Similar to the table 1200 illustrated in FIG. 12, a table 1200 in FIG. 36 illustrates a result of reception by the terminal 121 of searching beams from the base station 110.

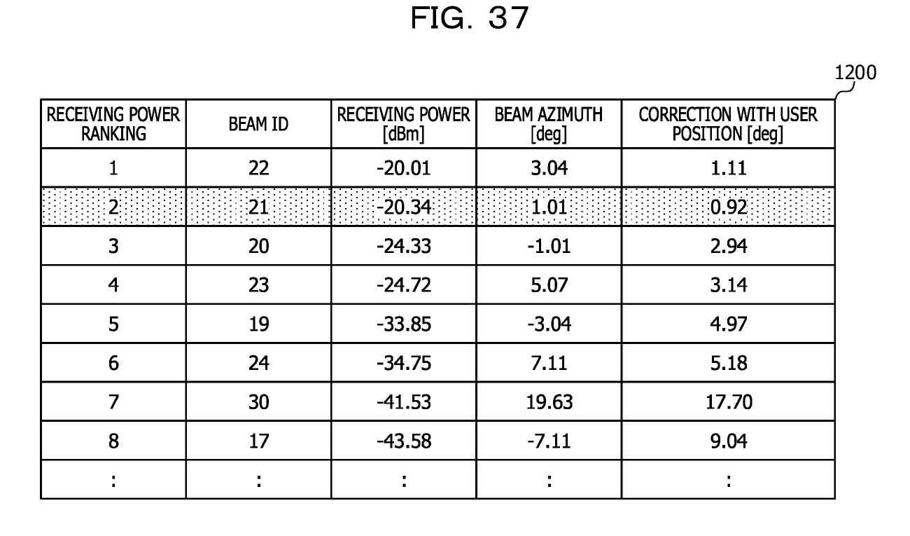

FIG. 37 is a diagram illustrating the table 1200 illustrated in FIG. 36 in a state sorted according to receiving power rankings. In the table 120, while an error with a user position for a beam ID=21 is smallest, due to an estimation error in the receiving power, receiving power of the searching beam of the beam ID=21 is lower than receiving power of the searching beam of a beam ID=22. As a result, the receiving power of the searching beam of the beam ID=21 is ranked second.

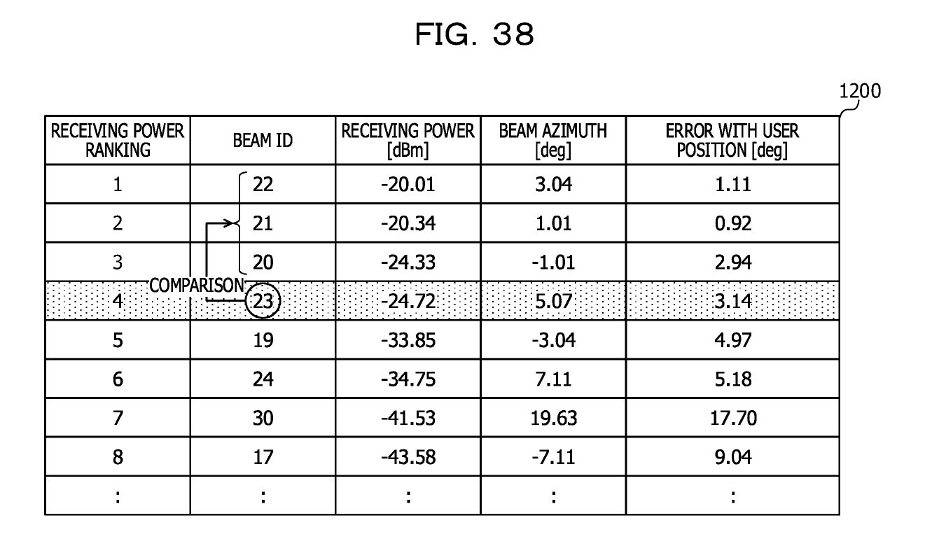

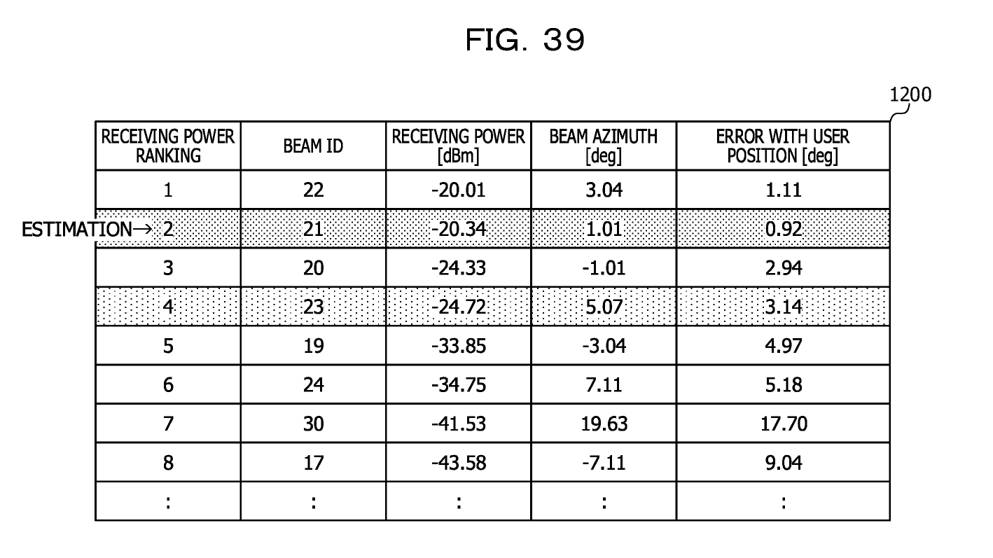

If the judgment ranking m described above is 4, as illustrated in FIG. 38, the terminal 121 compares a beam ID=23 with the fourth-ranking receiving power with beam IDs ID=22, 21, 20 with the first-ranking to third-ranking receiving powers. Then, because the beam ID=23 is larger than the beam IDs=22, 21, 20 and the judgment ranking m=4 is an even, the terminal 121 judges an estimation beam ID=23−(4/2)=21, as illustrated in FIG. 39. With this, the beam ID=21 whose receiving power is ranked second due to the error although offset in the actual azimuth is smallest, may be derived as the estimation beam ID. In addition, in this case, the terminal 121 is located in the first area 811.

In the estimation azimuth correction processing illustrated in FIG. 33, for example, the terminal 121 calculates an electric power difference between receiving power of the third-ranking beam ID and receiving power of the fourth-ranking beam ID as an evaluation value (when m=4). In this example, 0.39 is calculated as an evaluation value, as illustrated in FIG. 34. Also suppose that the threshold 3101 described above is 2.78.

In addition, suppose that the beam azimuth of the beam ID=20 is −1.01 [deg] and the beam azimuth of the beam ID=21 is 1.01 [deg]. In this case, the beam azimuth interval 2901 between the beam azimuth of the beam ID=20 and the beam azimuth of the beam ID=21 is 2.02 [deg].

In this case, m is an even (m=4), the evaluation value is the threshold or lower (0.39<2.78), and the terminal 121 is located in the first area 811. Thus, step S3305 illustrated in FIG. 33, for example is performed. More specifically, the terminal 121 performs correction to add beam azimuth interval/2=2.02/2 to the beam azimuth=1.01 indicated by the estimation beam ID=21 that is obtained through the azimuth estimation processing. This allows the beam ID indicating 2.02 [deg] to be obtained as the estimation beam ID after the correction.

(Improvement in Throughput According to Embodiment 3)

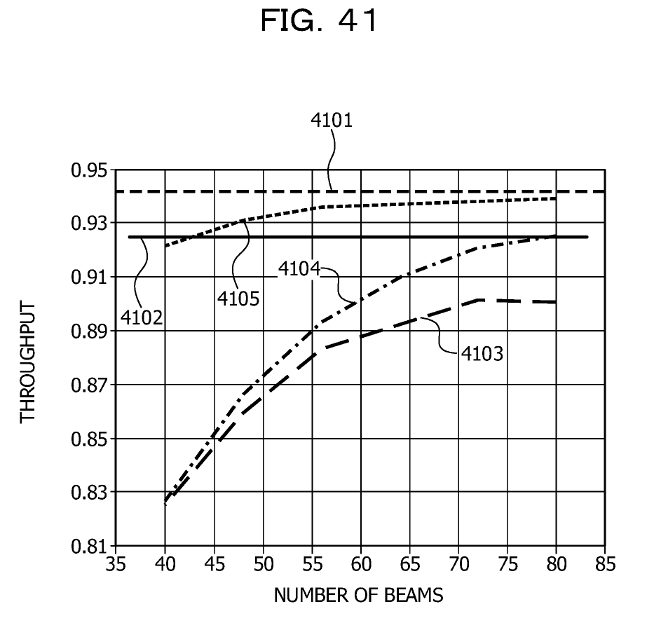

FIG. 41 is a diagram illustrating an example of improvement in throughput according to Embodiment 3. In FIG. 41, the horizontal axis represents the number of searching beams (number of beams) transmitted through beam searching and the vertical axis represents throughput between the base station 110 and the terminals 121 to 124. The throughput illustrated in FIG. 41 is throughput based on reception characteristics depending on estimation precision of a beam azimuth.

Simulation results 4101 to 4105 illustrated in FIG. 41 represent throughput to the number of beams if 16QAM is used for wireless signals from the base station 110 to the terminals 121 to 124. Note that simulation conditions are similar to the simulation conditions illustrated in FIG. 18, or the like.

The simulation result 4101 represents throughput for the number of beams when an optimal beam azimuth is known and the beam direction is used (search cunning). In this case, throughput is fixed irrespective of the number of beams. The simulation result 4102 represents throughput for the number of beams when there is no estimation error in receiving power. In this case, throughput is fixed irrespective of the number of beams.

The simulation result 4103 represents throughput for the number of beams in an average method wherein there is an estimation error in receiving power, a plurality of receptions are performed as usual for each beam ID, and a beam ID with the highest average receiving power is made an estimation beam ID.

The simulation result 4104 represents throughput for the number of beams in a case in which there is an estimation error in receiving powers and a judgment ranking m=4 in Embodiments 1 and 2. The simulation result 4105 represents throughput for the number of beams in a case in which there is an estimation error in receiving powers, and in Embodiment 3, the judgment ranking m=4 and the threshold 3101 is an intermediate value of electric power differences.

In any of the simulation results 4103 to 4105, throughput is improved because the more the number of beams is, the better the beam azimuth estimation precision is. In addition, in the simulation results 4104 and 4105 according to the Embodiments 1 to 3, throughput for the number of beams is higher than the conventional average method.

In addition, throughput for the number of beams=40 of the simulation result 4105 according to Embodiment 3, for example, is almost equivalent to the throughput for the number of beams=80 of the simulation result 4104 according to Embodiments 1 and 2. More specifically, with Embodiment 3, the number of beams may be reduced to almost half, while controlling reduction in throughput when compared with Embodiments 1 and 2.

(Improvement in Throughput According to Embodiment 3)

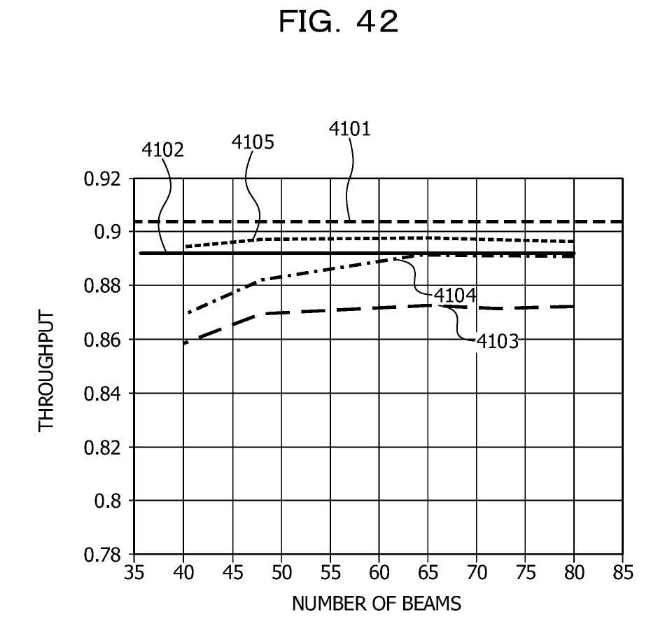

FIG. 42 is a diagram illustrating other example of the improvement in the throughput according to Embodiment 3. In FIG. 42, same symbols are assigned to parts similar to the parts illustrated in FIG. 41 and a description is omitted. If BPSK is used for wireless signals from the base station 110 to the terminals 121 to 124, simulation results 4101 to 4105 are as illustrated in FIG. 42.

Also in the example illustrated in FIG. 42, throughput for the number of beams=40 of the simulation result 4105 according to Embodiment 3, for example, is almost equivalent to throughput for the number of beams=80 of the simulation result 4104 according to Embodiments 1 and 2. More specifically, with Embodiment 3, the number of beams may be reduced to almost half, while controlling reduction in throughput when compared with Embodiments 1 and 2.

(Improvement in Throughput in Consideration of an Overhead Amount According to Embodiment 3)

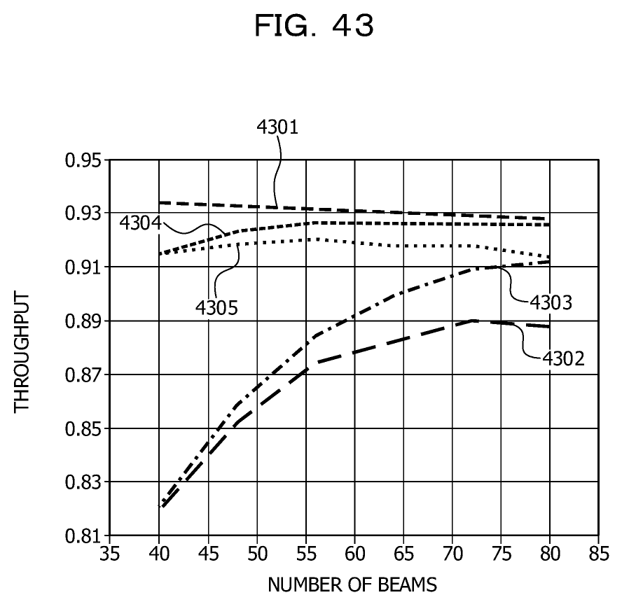

FIG. 43 is a diagram illustrating an example of improvement in the throughput in consideration of an overhead amount according to Embodiment 3. In FIG. 43, the horizontal axis represents the number of searching beams (number of beams) transmitted through beam searching and the vertical axis represents throughput between the base station 110 and the terminals 121 to 124. Throughput illustrated in FIG. 43 is throughput based on reception characteristics depending on an overhead amount of searching beams and estimation precision of a beam azimuth.

Simulation results 4301 to 4305 illustrated in FIG. 43 represent throughput for the number of beams if 16QAM is used for wireless signals from the base station 110 to the terminals 121 to 124. Note that simulation conditions are similar to the simulation conditions illustrated in FIG. 18 or the like.

The simulation result 4301 represents throughput for the number of beams in a case in which an optimal beam azimuth is known and the beam direction is used (search cunning). In this case, as the number of beams increases, the overhead amount increases and the throughput is reduced.

The simulation result 4302 represents throughput in an average method wherein there is an estimation error in receiving powers, a plurality of receptions are performed as usual for each beam ID, and a beam ID with the highest average receiving power is made an estimation beam ID. The simulation result 4303 represents throughput for the number of beams in a case in which there is an estimation error in receiving powers, and the judgment ranking m=4 in Embodiments 1 and 2.

The simulation result 4304 represents throughput for the number of beams in the case in which there is an estimation error in receiving powers, a difference between the fourth-ranking and the third-ranking receiving power is used in Embodiment 3, and the threshold 3101 is an intermediate value of electric power differences. The simulation result 4305 represents throughput for the number of beams in a case in which there is an estimation error in the receiving powers, the first-ranking and second-ranking receiving powers are used in Embodiment 3, and the threshold 3101 is the intermediate value of the electric power differences.

As illustrated in the simulation results 4304, 4305 according to Embodiment 3, since the low rankings having a small estimation error are used, the throughput may be improved by using a low judgment ranking m. Also in the example illustrated in FIG. 43, it is seen that the number of beams may be reduced while controlling reduction of the throughput.

(Other Example of Improvement in Throughput Considering the Overhead Amount According to Embodiment 3)

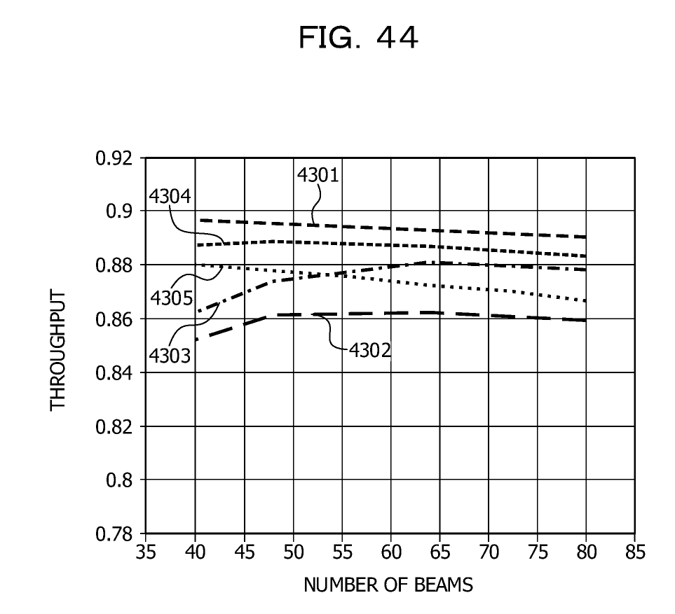

FIG. 44 is a diagram illustrating other example of the improvement in the throughput in consideration of the overhead amount according to Embodiment 3. In FIG. 44, same symbols are assigned to parts similar to the parts illustrated in FIG. 43 and a description is omitted. If BPSK is used for wireless signals from the base station 110 to the terminals 121 to 124, the simulation results 4301 to 4305 are as illustrated in FIG. 44.

Also in the example illustrated in FIG. 44, as illustrated in the simulation results 4304, 4305 according to Embodiment 3, since the low rankings with a small estimation error are used, throughput may be improved by using the low judgment ranking m. Also in the example illustrated in FIG. 44, it is seen that the number of beams may be reduced while controlling reduction of the throughput.

(Overhead of Beam Searching According to Embodiment 3)

Here, an overhead amount of beam searching according to Embodiment 3 is described. As described above, an overhead amount in wireless communications between the base station 110 and the terminal 121 may be expressed by the expression (2) mentioned above, for example.

By way of example, as described above, suppose that T_{packet} is 4.43 [μs], T_{margin} is 3[μs], L is 80, T_{gt} is 50 [μs], and T_{bs} is 45 [μs]. In this case, with the estimation method according to Embodiment 3, an overhead amount based on the expression (2) above is 0.77[%] when the number of beams=40, 0.9[%] when the number of beams=48, and 1.04[%] when the number of beams=56. In addition, the overhead amount is 1.17[%] when the number of beams=64, 1.30[%] when the number of beams=72, and 1.43[%] when the number of beams=80.

As such, with Embodiment 3, correction processing of the estimated direction that is calculated based on the comparison result of azimuths of respective beams as described above may be performed based on a difference in receiving power between the first beam and the second beam with continuously-ranking receiving powers. With this, a user direction may be estimated with precision, even when the number of beams to be transmitted for calculation of an estimated direction is small.

For example, as illustrated in FIG. 33, correction processing may be performed based on the result of comparison of the difference in the receiving power between the first beam and the second beam with the threshold. Alternatively, as illustrated in FIG. 35, for the continuous first beam, second beam and third beam, the correction processing may be performed based on a result of comparison of the difference in the receiving power between the first beam and the second beam with the difference in the receiving power between the second beam and the third beam. In this case, since the threshold 3101 does not have to be determined depending on the electric power difference characteristic such as the electric power difference characteristic 3003 illustrated in FIG. 31 or the like, for example, the processing may be simplified.

In addition, in Embodiment 3, as illustrated in FIGS. 16 and 17, for example, a configuration may be such that estimation of a user direction based on an estimation value of receiving power for each beam ID is performed in the base station 110. In addition, in Embodiment 2, estimation of a user direction including the countermeasure for an exception illustrated in FIGS. 23 and 24, for example, may also be performed.

In addition, in Embodiment 3, a configuration may be such that beams are beams that have different combinations of a first direction (horizontal azimuth, for example) and a second direction (vertical azimuth, for example) from each other, as with Embodiment 2, for example.

In addition, in the embodiments described above, while the configuration in which the base station 110 performs data transmission through multiuser multiplexing among the terminals 121 to 12M, a configuration may be such that the base station 110 performs data transmission with one terminal (M=1). Also in this case, beamforming may be performed by estimating a direction of one terminal with precision, thereby being able to improve reception characteristics in that terminal.

In addition, in the embodiments described above, while the configuration is described in which the base station 110 estimates directions of the terminals 121 to 12M by performing beam searching for the terminals 121 to 12M, the configuration is not limited to this. For example, a wireless communication apparatus that transmits a searching beam is not limited to the base station 110, but may be various types of wireless communication apparatuses such as a terminal or a relay device, or the like. In addition, an estimation target of a direction is not limited to the terminals 121 to 12M, but may be various types of wireless communication apparatuses such as a base station or a relay device.

As described above, with the wireless communication apparatus, the wireless communication system, and estimation method, estimation precision of a user direction may be improved.

For example, in the conventional beam searching method, as described above, if an error is in an estimation value of receiving power of a searching beam, an error in an estimated direction increases. Error factors of an estimation value include an error due to implementation such as noise, quantization error, phase shifter error or the like. When an error in an estimated direction is large, reception characteristics (such as an error rate) on the receiving side are deteriorated. When interference control is done such as multiuser multiplexing, in particular, null does not face an interfering direction appropriately, thus resulting in reduction in signal-to-interference ratio (SIR), and larger deterioration of the reception characteristics.

In contrast to this, a method is possible that averages an error by increasing the number of transmission packets and transmitting in a same direction a plurality of times, and improves the characteristics. However, since the number of transmission packets increases, the overhead increases, which contributes to reduced throughput.

In contrast to this, with the embodiments described above, a direction may be estimated, for example, from a relatively small value of receiving power (the third-ranking or fourth-ranking receiving power, for example), and not from the highest value of receiving power. For example, if the third ranking or the fourth ranking is learned from shape of a beam pattern, for example, the first ranking may be estimated. Furthermore, as the ranking of receiving power lowers, SNR is reduced and error dispersion width increases. However, since an electric power difference between the rankings becomes wider than that, there is robustness to variations (see FIG. 6, for example). Therefore, a ranking of receiving power which is ranked lower is less likely to be mistaken (see FIG. 7, for example). Use of this method may improve the estimation precision of a user direction even if the number of transmission packets or amount of calculation is not increased.

For example, suppose that at least three adjacent beams with adjacent azimuths (beam IDs) may be received and a beam ID with the third-ranking receiving power is used as a reference. Focusing on the first ranking to the third ranking, a beam searching interval may be divided to the first area 811 and the second area 812 (see FIG. 8, for example).

Then, in the first area 811, the first- and second-ranking beam IDs are larger than the third-ranking beam ID at all times, and in the second area 812, the first- and second-ranking beam IDs are smaller than the third-ranking beam ID at all times (see FIG. 8, for example). Therefore, an area may be determined based on a ranking magnitude relation of receiving powers, and if an area is determined, the true first-ranking receiving power, more specifically, a user direction, may be estimated. With this, a user direction may be estimated with precision.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A wireless communication apparatus comprising:
a receiver configured to receive a plurality of beams output from external devices, the beams having directions different from each other, respectively;
a memory;
a processor coupled to the memory and configured to:
decide ranking of receiving powers of beams based on the receiving powers received by the receiver;
calculate an estimated direction of the beam corresponding to the highest receiving power based on comparison of a receiving power whose ranking decided by the ranking is a predetermined ranking or lower with a receiving power whose ranking is higher than the predetermined ranking; and
output a signal indicating the calculated estimated direction.

2. The wireless communication apparatus according to claim 1, wherein the predetermined ranking is such that the reception quality of the plurality of beams is higher than predetermined quality.

3. The wireless communication apparatus according to claim 2, wherein the predetermined ranking is the lowest ranking among the rankings of receiving powers of the plurality of beams having the reception quality higher than the predetermined quality.

4. The wireless communication apparatus according to claim 1, the processor configured to:
associate an identifier having a magnitude corresponding to the direction of each of the plurality of beams; and
calculate the estimated direction based on a magnitude relation between the identifier of a direction for which the ranking decided by the ranking is the predetermined ranking and the identifier of each direction for which the ranking decided by the ranking is higher than the predetermined ranking.

5. The wireless communication apparatus according to claim 4, the processor configured to calculate the estimated direction based on whether the predetermined ranking is an even or an odd and the magnitude relation.

6. The wireless communication apparatus according to claim 4, the processor configured to:
when identifiers of respective directions for each of which the ranking decided by the ranking is the predetermined ranking or higher include an identifier which is equal to or larger than a value obtained by subtracting the predetermined ranking from the largest identifier among the identifiers of the respective directions of the plurality of beams, calculate the estimated direction after subtracting the value of the largest identifier from the identifier which is larger than the value obtained by subtracting the predetermined ranking; and
when the value of the largest identifier is subtracted from the identifier of the direction of the predetermined ranking, calculate the estimated direction by adding the largest identifier to the identifier indicating the calculated estimated direction.

7. The wireless communication apparatus according to claim 1, wherein
each of the directions of the plurality of beams is a combination of information in a first direction and information in a second direction which is different from the first direction, and
the processor configured to:
based on one or more directions among the respective directions of the plurality of beams, the one or more directions including the same second direction but including the different first directions, calculate the estimated direction of the second direction in each of the one or more directions,
calculate an estimated direction of the first direction based on the calculation result,
based on one or more directions among the respective directions of the plurality of beams, the one or more directions including the same first direction but including the different second directions, calculate the estimated direction of the first direction in each of the one or more directions,
calculate an estimated direction of the second direction based on the calculation result, and
output a signal indicating the estimated direction of the first direction and the estimated direction of the second direction that are thus estimated.

8. The wireless communication apparatus according to claim 1, the processor configured to:
correct processing of correcting the estimated direction calculated based on the comparison, based on a difference in receiving power between a first beam and a second beam that are included in the plurality of beams and whose rankings decided by the ranking are continuous, and
output a signal indicating the estimated direction thus corrected.

9. The wireless communication apparatus according to claim 8, the processor configured to correct processing based on a result of comparison of the difference in receiving power between the first beam and the second beam in the wireless communication apparatus with a threshold.

10. The wireless communication apparatus according to claim 8, the processor configured to correct processing for the first beam, the second beam, and a third beam that are included in the plurality of beams and whose rankings decided by the ranking are continuous, based on comparison of the difference in the receiving power between the first beam and the second beam with the difference in the receiving power between the second beam and the third beam.

11. A wireless communication system comprising:
a first wireless communication apparatus configured to send a plurality of beams whose directions are different from each other, respectively;
a second wireless communication apparatus including:
a receiver configured to receive the plurality of beams;
a memory; and
a processor coupled to the memory and configured to:
decide ranking of receiving powers of beams based on the receiving powers received by the receiver;
calculate an estimated direction of the beam corresponding to the highest receiving power based on comparison of a receiving power whose ranking decided by the ranking is a predetermined ranking or lower with a receiving power whose ranking is higher than the predetermined ranking; and
send a signal indicating the calculated estimated direction to the first wireless communication apparatus,
wherein the first wireless communication apparatus controls a beam for sending data to the second wireless communication apparatus on the basis of the estimated direction.

12. An estimation method comprising:
receiving, by a processor, a plurality of beams output from external devices, the beams having directions different from each other, respectively;
deciding, by a processor, ranking of receiving powers of beams based on the receiving powers;
calculating, by a processor, an estimated direction of the beam corresponding to the highest receiving power based on comparison of a receiving power whose ranking decided by the ranking is a predetermined ranking or lower with a receiving power whose ranking is higher than the predetermined ranking; and
outputting, by a processor, a signal indicating the calculated estimated direction.
